(19) United States
(12) Patent Application Publication
(10) Pub. No.: US 2025/0370782 A1
(43) Pub. Date: Dec. 4, 2025

(54) Incrementally Delivering Fragmented Stream Data

(71) Applicant: Oracle International Corporation, Redwood Shores, CA (US)

(72) Inventors: Aleksei Efimov, Dublin (IE); Daniel Jean-Michel Fuchs, Dublin (IE); Daniel Jelinski, Gdansk (PL); Jaikiran Pai, Dharwad (IN)

(73) Assignee: Oracle International Corporation, Redwood Shores, CA (US)

(21) Appl. No.: 19/084,300

(22) Filed: Mar. 19, 2025

Related U.S. Application Data
(60) Provisional application No. 63/654,509, filed on May 31, 2024.

(51) Int. Cl. G06F 9/455; H04L 67/02

(52) U.S. Cl. CPC G06F 9/45516; H04L 67/02

(57) ABSTRACT

Techniques for incrementally delivering stream data are disclosed. A system receives a portion of a unit of stream data and decodes metadata included in the portion of the unit of stream data. Based on the decoded metadata, the system determines that data included in the portion of the unit of stream data will be delivered without waiting for a remainder of the unit of stream data to be received by the system. The system generates a runtime object to track the incremental delivery of data in the unit of stream data, and decodes data included in the portion of the unit of stream data. The system delivers the decoded data to a stream recipient. When the remainder of the unit of stream data is received, that remainder of the unit of stream data is decoded and delivered to the stream recipient.

### BENEFIT CLAIMS; RELATED APPLICATIONS; INCORPORATION BY REFERENCE

This application claims the benefit of U.S. Provisional Patent Application 63/654,509, filed on May 31, 2024, that is hereby incorporated by reference.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to stream data. In particular, the present disclosure relates to delivering stream data.

### BACKGROUND

A data stream is a sequence of related, digitally encoded signals that are transmitted through a communication network. A communication network is two or more devices that are communicatively coupled by at least one network link. Devices in a communication network may include one or more software devices (e.g., virtual machines, cloud-based applications, software-defined networking controllers, etc.), hardware devices (e.g., routers, switches, hubs, etc.), and/or devices that combine both software and hardware (e.g., smartphones, servers, IoT devices, etc.). Network links in a communication network may include one or more wireless network links and/or wired network links.

Typically, a data stream is associated with at least one communication protocol. A communication protocol is a set of rules that govern how information is transmitted through a communication network. Among other aspects of a data stream, a communication protocol may dictate how units of data within the data stream are formatted and organized. Example units of stream data that may be found within a data stream include network packets, protocol frames, segments, bytes, bits, and other units of stream data.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates an example computing architecture that techniques described herein may be practiced according to an embodiment;

FIG. 2 is a block diagram illustrating one embodiment of a computer system suitable for implementing methods and features described herein;

FIG. 3 illustrates an example virtual machine memory layout in block diagram form according to an embodiment;

FIG. 4 illustrates an example frame in block diagram form according to an embodiment;

FIG. 5 illustrates a system for practicing techniques described herein according to an embodiment;

FIG. 6 illustrates example operations for parsing stream data according to an embodiment;

FIG. 7 illustrates example operations for delivering stream data according to an embodiment;

FIG. 8 illustrates example operations for retrieving an outgoing frame according to an embodiment;

FIG. 9 illustrates example operations for decoding an outgoing frame according to an embodiment;

FIG. 10 illustrates example operations for decoding payload data of a partial frame according to an embodiment;

FIG. 11 illustrates an example network packet according to an example embodiment;

FIG. 12 illustrates example operations for delivering payload data according to an example embodiment; and

FIG. 13 is a block diagram that illustrates a computer system according to an embodiment.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.

The following table of contents is provided for the reader's convenience and is not intended to define the limits of the disclosure.
1. GENERAL OVERVIEW
2. ARCHITECTURAL OVERVIEW
   2.1 EXAMPLE CLASS FILE STRUCTURE
   2.2 EXAMPLE VIRTUAL MACHINE ARCHITECTURE
   2.3 LOADING, LINKING, AND INITIALIZING
3. STREAM DATA PARSING SYSTEM
4. PARSING STREAM DATA
5. DELIVERING STREAM DATA
6. RETRIEVING AN OUTGOING FRAME
7. DECODING AN OUTGOING FRAME
8. DECODING PAYLOAD DATA OF A PARTIAL FRAME
9. EXAMPLE EMBODIMENT
   9.1 EXAMPLE PACKET ARCHITECTURE
   9.2 EXAMPLE PAYLOAD DATA DELIVERY
10. HARDWARE OVERVIEW
11. MISCELLANEOUS; EXTENSIONS

### 1. GENERAL OVERVIEW

One or more embodiments use incremental delivery to improve the performance of transmitting a stream of data. Incrementally delivering data decoded from the multiple portions of a unit of stream data allows the system to begin delivering data to the stream recipient sooner than if the system were made to wait for the entire unit of stream data to become available for decoding. By beginning delivery of data included in the unit of stream data sooner than might otherwise occur, the system may reduce latency in a data stream that includes the unit of stream data. Furthermore, incrementally delivering data included in the unit of stream data may allow the system to reclaim memory space occupied by one portion of the unit of stream data, prior to another portion of the unit of stream data being stored in memory. As a result, the amount of memory space that needs to be allocated for buffering the unit of stream data may be reduced, because there may be no point in time where the system is forced to buffer the entire unit of stream data.

In an embodiment, a system decodes metadata from a portion of the unit of stream data and determines, based on the metadata, that data included in the unit of stream data will be delivered to a stream recipient incrementally. The system generates an abstraction of the unit of stream data that will be used to manage the incremental delivery of data included in the unit of stream data, decodes any data intended for the stream recipient that is included in the portion of the unit of stream data, and delivers the decoded information to the stream recipient prior to another portion of the unit of stream data becoming available for decoding. The system updates the abstraction of the unit of stream data to reflect the delivery of the decoded information. As other portion(s) of the unit of stream data are received by the system and become available for decoding, the system decodes and delivers data from the other portion(s).

In an embodiment, a system receives a portion of a protocol frame, buffers the portion of the protocol frame in memory, and decodes frame metadata from the portion of the protocol frame. Based on the frame metadata, the system determines that the protocol frame will be modeled as a partial frame. As used herein, the term “partial frame” refers to an abstraction of a protocol frame that the system can use to decode and deliver data included in the protocol frame incrementally. The partial frame tracks the state of the protocol frame and serves as a mechanism for decoding data included in the protocol frame. The system generates a partial frame to represent the protocol frame, decodes data included in the portion of the protocol frame that is intended for a stream recipient, and delivers the decoded data to a stream recipient prior to another portion of the protocol frame becoming available for decoding. The system updates the partial frame to reflect the delivery of decoded data to the stream recipient. After delivering data decoded from the portion of the protocol frame the stream recipient, the system may reclaim the memory space that is occupied by the portion of the protocol frame while retaining the partial frame in memory. Using the partial frame, the system decodes and delivers data included in the other portion(s) of the protocol frame as the other portion(s) of the protocol frame are received by the system and become available for decoding.

In an embodiment, a system receives a portion of a protocol frame, buffers the portion of the protocol frame, and decodes frame metadata from the portion of the protocol frame. Based on the frame metadata, the system determines if the protocol frame should be modeled as a partial frame, a complete frame, or a malformed frame. Frame metadata used to determine how the protocol frame will be modeled may include, for example, one or more of: the frame type of the protocol frame; the frame length of the protocol frame; a protocol associated with the protocol frame; and/or other information associated with the protocol frame. As used herein, the term “complete frame” refers to an abstraction of a protocol frame that (a) is not modeled as a partial frame and (b) is not delivered and decoded incrementally. The term “malformed frame” refers to an abstraction of a protocol frame that is associated with some malformity. If a protocol frame is modeled as a partial frame and the entire protocol frame is not yet available for decoding, the system may decode and deliver data included in the protocol frame incrementally. However, if (a) the protocol frame is modeled as a partial frame and (b) the entire protocol frame is presently available for decoding, the system may not need to decode and deliver the data included in the protocol frame incrementally. If the protocol frame is modeled as complete frame, the system may decode and deliver the data included in the protocol frame once the entire protocol frame is available for decoding. If the protocol frame is modeled as a malformed frame, the system may trigger a protocol error that (a) terminates a data stream that includes the protocol frame, (b) terminates a network connection that is used to establish the data stream, and/or (c) takes some other action to handle the malformed frame.

One or more embodiments described in this Specification and/or recited in the claims may not be included in this General Overview section.

### 2. ARCHITECTURAL OVERVIEW

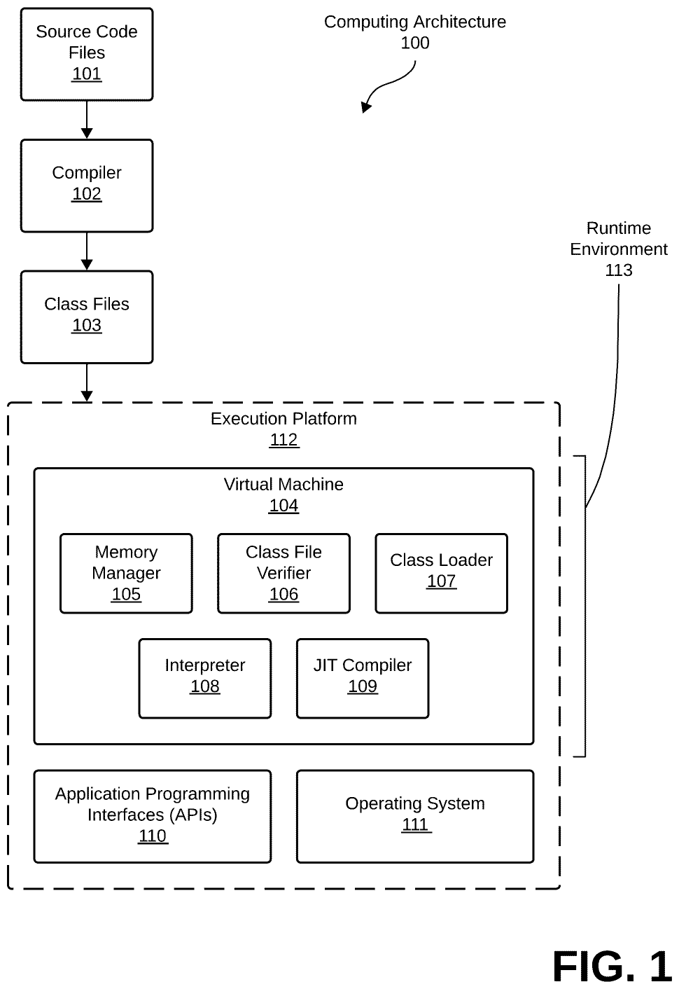

FIG. 1 illustrates an example architecture in which techniques described herein may be practiced. Software and/or hardware components described with relation to the example architecture may be omitted or associated with a different set of functionality than described herein. Software and/or hardware components, not described herein, may be used within an environment in accordance with one or more embodiments. Accordingly, the example environment should not be constructed as limiting the scope of any of the claims.

As illustrated in FIG. 1, a computing architecture 100 includes source code files 101 which are compiled by a compiler 102 into class files 103 representing the program to be executed. The class files 103 are then loaded and executed by an execution platform 112, which includes a runtime environment 113, an operating system 111, and one or more application programming interfaces (APIs) 110 that enable communication between the runtime environment 113 and the operating system 111. The runtime environment 113 includes a virtual machine 104 comprising various components, such as a memory manager 105 (which may include a garbage collector), a class file verifier 106 to check the validity of class files 103, a class loader 107 to locate and build in-memory representations of classes, an interpreter 108 for executing the virtual machine 104 code, and a just-in-time (JIT) compiler 109 for producing optimized machine-level code.

In an embodiment, the computing architecture 100 includes source code files 101 that contain code that has been written in a particular programming language, such as Java, C, C++, C#, Ruby, Perl, etc. Thus, the source code files 101 adhere to a particular set of syntactic and/or semantic rules for the associated language. For example, code written in Java adheres to the Java Language Specification. However, since specifications are updated and revised over time, the source code files 101 may be associated with a version number indicating the revision of the specification to which the source code files 101 adhere. The exact programming language used to write the source code files 101 is generally not critical.

In various embodiments, the compiler 102 converts the source code, which is written according to a specification directed to the convenience of the programmer, to either machine or object code, which is executable directly by the particular machine environment, or an intermediate representation (“virtual machine code/instructions”), such as bytecode, which is executable by a virtual machine 104 that is capable of running on top of a variety of particular machine environments. The virtual machine instructions are executable by the virtual machine 104 in a more direct and efficient manner than the source code. Converting source code to virtual machine instructions includes mapping source code functionality from the language to virtual machine functionality that utilizes underlying resources, such as data structures. Often, functionality that is presented in simple terms via source code by the programmer is converted into more complex steps that map more directly to the instruction set supported by the underlying hardware on which the virtual machine 104 resides.

In general, programs are executed either as a compiled or an interpreted program. When a program is compiled, the code is transformed globally from a first language to a second language before execution. Since the work of transforming the code is performed ahead of time; compiled code tends to have excellent runtime performance. In addition, since the transformation occurs globally before execution, the code can be analyzed and optimized using techniques such as constant folding, dead code elimination, inlining, etc. However, depending on the program being executed, the startup time can be significant. In addition, inserting new code would require the program to be taken offline, re-compiled, and re-executed. For many dynamic languages (such as Java) which are designed to allow code to be inserted during the program's execution, a purely compiled approach may be inappropriate. When a program is interpreted, the code of the program is read line-by-line and converted to machine-level instructions while the program is executing. As a result, the program has a short startup time (can begin executing almost immediately), but the runtime performance is diminished by performing the transformation at runtime. Furthermore, since various instructions are analyzed individually, many optimizations that rely on a more global analysis of the program cannot be performed.

In some embodiments, the virtual machine 104 includes an interpreter 108 and a JIT compiler 109 (or a component implementing aspects of both), and executes programs using a combination of interpreted and compiled techniques. For example, the virtual machine 104 may initially begin by interpreting the virtual machine instructions representing the program via the interpreter 108 while tracking statistics related to program behavior, such as how often different sections or blocks of code are executed by the virtual machine 104. Once a block of code surpasses a threshold (is “hot”), the virtual machine 104 invokes the JIT compiler 109 to perform an analysis of the block and generate optimized machine-level instructions which replaces the “hot” block of code for future executions. Since programs tend to spend most time executing a small portion of overall code, compiling just the “hot” portions of the program can provide similar performance to fully compiled code, but without the start-up penalty. Furthermore, although the optimization analysis is constrained to the “hot” block being replaced, there still exists far greater optimization potential than converting instructions individually. There are several variations on the above described example, such as tiered compiling.

In order to provide clear examples, the source code files 101 have been illustrated as the “top level” representation of the program to be executed by the execution platform 112. Although the computing architecture 100 depicts the source code files 101 as a “top level” program representation, in other embodiments the source code files 101 may be an intermediate representation received via a “higher level” compiler that processed code files in a different language into the language of the source code files 101. Some examples in the following disclosure assume that the source code files 101 adhere to a class-based object-oriented programming language. However, this is not a requirement to utilizing the features described herein.

In an embodiment, compiler 102 receives as input the source code files 101 and converts the source code files 101 into class files 103 that are in a format expected by the virtual machine 104. For example, in the context of the JVM, the Java Virtual Machine Specification defines a particular class file format to which the class files 103 are expected to adhere. In some embodiments, the class files 103 contain the virtual machine instructions that have been converted from the source code files 101. However, in other embodiments, the class files 103 may contain other structures as well, such as tables identifying constant values and/or metadata related to various structures (classes, fields, methods, etc.).

The following discussion assumes that the class files 103 represents a respective “class” defined in the source code files 101 (or dynamically generated by the compiler 102/virtual machine 104). However, the aforementioned assumption is not a strict requirement and will depend on the implementation of the virtual machine 104. Thus, the techniques described herein may still be performed regardless of the exact format of the class files 103. In some embodiments, the class files 103 are divided into one or more “libraries” or “packages”, each of which includes a collection of classes that provide related functionality. For example, a library may contain one or more class files that implement input/output (I/O) operations, mathematics tools, cryptographic techniques, graphics utilities, etc. Further, some classes (or fields/methods within those classes) may include access restrictions that limit their use to within a particular class/library/package or to classes with appropriate permissions.

### 2.1 Example Class File Structure

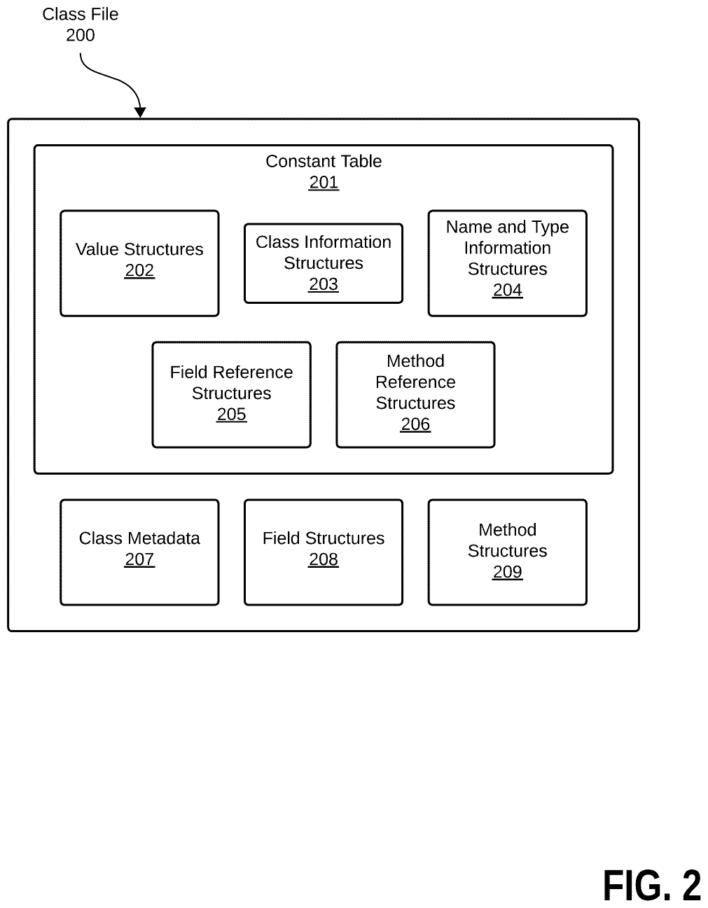

FIG. 2 illustrates an example structure for a class file 200 in block diagram form according to an embodiment. In order to provide clear examples, the remainder of the disclosure assumes that the class files 103 of the computing architecture 100 adhere to the structure of the example class file 200 described in this section. However, in a practical environment, the structure of the class file 200 will be dependent on the implementation of the virtual machine 104. Further, one or more features discussed herein may modify the structure of the class file 200 to, for example, add additional structure types. Therefore, the exact structure of the class file 200 is not critical to the techniques described herein. For the purposes of Section 2.1, “the class” or “the present class” refers to the class represented by the class file 200.

In FIG. 2, the class file 200 includes a constant table 201, class metadata 207, field structures 208, and method structures 209. In an embodiment, the constant table 201 is a data structure which, among other functions, acts as a symbol table for the class. For example, the constant table 201 may store data related to the various identifiers used in the source code files 101 such as type, scope, contents, and/or location. The constant table 201 has entries for value structures 202 (representing constant values of type int, long, double, float, byte, string, etc.), class information structures 203, name and type information structures 204, field reference structures 205, and method reference structures 206 derived from the source code files 101 by the compiler 102. In an embodiment, the constant table 201 is implemented as an array that maps an index i to structure j. However, the exact implementation of the constant table 201 is not critical.

In some embodiments, the entries of the constant table 201 include structures which index other constant table 201 entries. For example, an entry for one of the value structures 202 representing a string may hold a tag identifying its “type” as string and an index to one or more other value structures 202 of the constant table 201 storing char, byte or int values representing the ASCII characters of the string.

In an embodiment, field reference structures 205 of the constant table 201 hold an index into the constant table 201 to one of the class information structures 203 representing the class defining the field and an index into the constant table 201 to one of the name and type information structures 204 that provides the name and descriptor of the field. Method reference structures 206 of the constant table 201 hold an index into the constant table 201 to one of the class information structures 203 representing the class defining the method and an index into the constant table 201 to one of the name and type information structures 204 that provides the name and descriptor for the method. The class information structures 203 hold an index into the constant table 201 to one of the value structures 202 holding the name of the associated class.

The name and type information structures 204 hold an index into the constant table 201 to one of the value structures 202 storing the name of the field/method and an index into the constant table 201 to one of the value structures 202 storing the descriptor.

In an embodiment, class metadata 207 includes metadata for the class, such as version number(s), number of entries in the constant pool, number of fields, number of methods, access flags (if the class is public, private, final, abstract, etc.), an index to one of the class information structures 203 of the constant table 201 that identifies the present class, an index to one of the class information structures 203 of the constant table 201 that identifies the superclass (if any), etc.

In an embodiment, the field structures 208 represent a set of structures that identifies the various fields of the class. The field structures 208 store, for a field of the class, accessor flags for the field (if the field is static, public, private, final, etc.), an index into the constant table 201 to one of the value structures 202 that holds the name of the field, and an index into the constant table 201 to one of the value structures 202 that holds a descriptor of the field.

In an embodiment, the method structures 209 represent a set of structures that identifies the various methods of the class. The method structures 209 store, for a method of the class, accessor flags for the method (e.g. if the method is static, public, private, synchronized, etc.), an index into the constant table 201 to one of the value structures 202 that holds the name of the method, an index into the constant table 201 to one of the value structures 202 that holds the descriptor of the method, and the virtual machine instructions that correspond to the body of the method as defined in the source code files 101.

In an embodiment, a descriptor represents a type of a field or method. For example, the descriptor may be implemented as a string adhering to a particular syntax. While the exact syntax is not critical, a few examples are described below.

In an example where the descriptor represents a type of the field, the descriptor identifies the type of data held by the field. In an embodiment, a field can hold a basic type, an object, or an array. When a field holds a basic type, the descriptor is a string that identifies the basic type (e.g., “B”=byte, “C”=char, “D”=double, “F”=float, “I”=int, “J”=long int, etc.). When a field holds an object, the descriptor is a string that identifies the class name of the object (e.g. “L ClassName”). “L” in this case indicates a reference, thus “L ClassName” represents a reference to an object of class ClassName. When the field is an array, the descriptor identifies the type held by the array. For example, “[B” indicates an array of bytes, with “[” indicating an array and “B” indicating that the array holds the basic type of byte. However, since arrays can be nested, the descriptor for an array may also indicate the nesting. For example, “[[L ClassName” indicates an array where an index holds an array that holds objects of class ClassName. In some embodiments, the ClassName is fully qualified and includes the simple name of the class, as well as the pathname of the class. For example, the ClassName may indicate where the file is stored in the package, library, or file system hosting the class file 200.

In the case of a method, the descriptor identifies the parameters of the method and the return type of the method. For example, a method descriptor may follow the general form “({ParameterDescriptor}) ReturnDescriptor”, where the {ParameterDescriptor} is a list of field descriptors representing the parameters and the ReturnDescriptor is a field descriptor identifying the return type. For instance, the string “V” may be used to represent the void return type. Thus, a method defined in the source code files 101 as “Object m(int I, double d, Thread t) { . . . }” matches the descriptor “(I D L Thread) L Object”.

In an embodiment, the virtual machine instructions held in the method structures 209 include operations which reference entries of the constant table 201. Using Java as an example, consider the following class:

```
class A
{
  int add12and13( ) {
    return B.addTwo(12, 13);
  }
}
```

In the above example, the Java method add12and13 is defined in class A, takes no parameters, and returns an integer. The body of method add12 and13 calls static method addTwo of class B which takes the constant integer values 12 and 13 as parameters, and returns the result. Thus, in the constant table 201, the compiler 102 includes, among other entries, a method reference structure that corresponds to the call to the method B.addTwo. In Java, a call to a method compiles down to an invoke command in the bytecode of the JVM (in this case invokestatic as addTwo is a static method of class B). The invoke command is provided an index into the constant table 201 corresponding to the method reference structure that identifies the class defining addTwo “B”, the name of addTwo “addTwo”, and the descriptor of addTwo “(I I)I”. For example, assuming the aforementioned method reference is stored at index 4, the bytecode instruction may appear as “invokestatic #4”.

Since the constant table 201 refers to classes, methods, and fields symbolically with structures carrying identifying information, rather than direct references to a memory location, the entries of the constant table 201 are referred to as “symbolic references”. One reason that symbolic references are utilized for the class files 103 is because, in some embodiments, the compiler 102 is unaware of how and where the classes will be stored once loaded into the runtime environment 113. As will be described in Section 2.3, eventually the runtime representations of the symbolic references are resolved into actual memory addresses by the virtual machine 104 after the referenced classes (and associated structures) have been loaded into the runtime environment and allocated concrete memory locations.

### 2.2 Example Virtual Machine Architecture

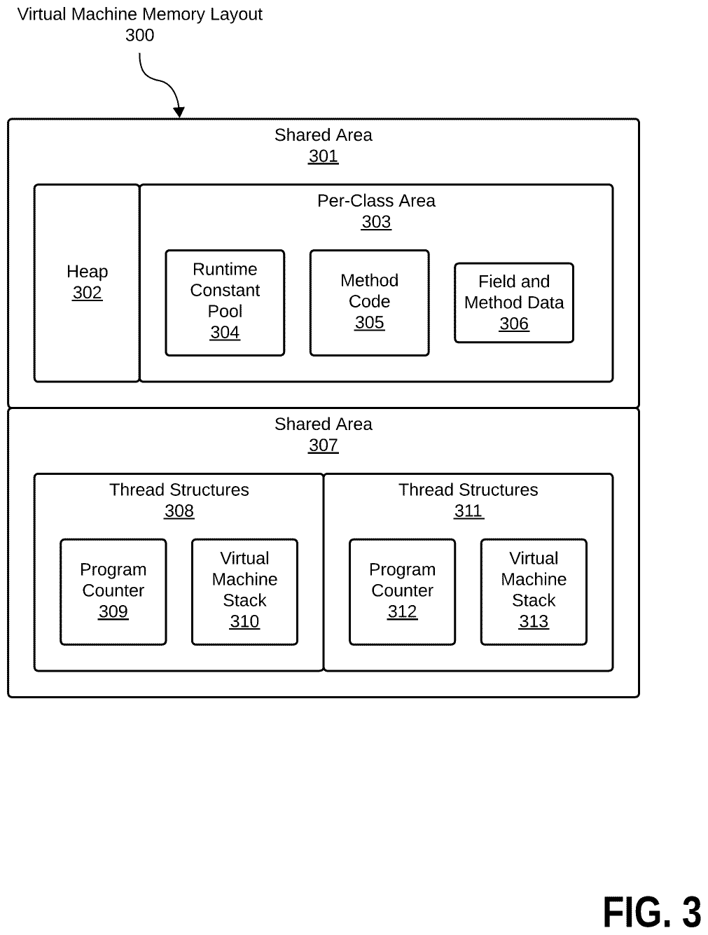

FIG. 3 illustrates an example virtual machine memory layout 300 in block diagram form according to an embodiment. In order to provide clear examples, the remaining discussion will assume that the virtual machine 104 adheres to the virtual machine memory layout 300 depicted in FIG. 3. In addition, although components of the virtual machine memory layout 300 may be referred to as memory “areas”, there is no requirement that the memory areas are contiguous.

In the example illustrated by FIG. 3, the virtual machine memory layout 300 is divided into a shared area 301 and a thread area 307. The shared area 301 represents an area in memory where structures shared among the various threads executing on the virtual machine 104 are stored. The shared area 301 includes a heap 302 and a per-class area 303. In an embodiment, the heap 302 represents the runtime data area from which memory for class instances and arrays is allocated. In an embodiment, the per-class area 303 represents the memory area where the data pertaining to the individual classes are stored. In an embodiment, the per-class area 303 includes, for a loaded class, a runtime constant pool 304 representing data from the constant table 201 of the class, field and method data 306 (for example, to hold the static fields of the class), and the method code 305 representing the virtual machine instructions for methods of the class.

The thread area 307 represents a memory area where structures specific to individual threads are stored. In FIG. 3, the thread area 307 includes thread structures 308 and thread structures 311, representing the per-thread structures utilized by different threads. In order to provide clear examples, the thread area 307 depicted in FIG. 3 assumes two threads are executing on the virtual machine 104. However, in a practical environment, the virtual machine 104 may execute any arbitrary number of threads, with the number of thread structures scaled accordingly.

In an embodiment, thread structures 308 includes program counter 309 and virtual machine stack 310. Similarly, thread structures 311 includes program counter 312 and virtual machine stack 313. In an embodiment, program counter 309 and program counter 312 store the current address of the virtual machine instruction being executed by their respective threads.

Thus, as a thread steps through the instructions, the program counters are updated to maintain an index to the current instruction. In an embodiment, virtual machine stack 310 and virtual machine stack 313 store frames for their respective threads that hold local variables and partial results, and is also used for method invocation and return.

In an embodiment, a frame is a data structure used to store data and partial results, return values for methods, and perform dynamic linking. A new frame is created each time a method is invoked. A frame is destroyed when the method that caused the frame to be generated completes. Thus, when a thread performs a method invocation, the virtual machine 104 generates a new frame and pushes that frame onto the virtual machine stack associated with the thread.

When the method invocation completes, the virtual machine 104 passes back the result of the method invocation to the previous frame and pops the current frame off of the stack. In an embodiment, for a given thread, one frame is active at any point. This active frame is referred to as the current frame, the method that caused generation of the current frame is referred to as the current method, and the class to which the current method belongs is referred to as the current class.

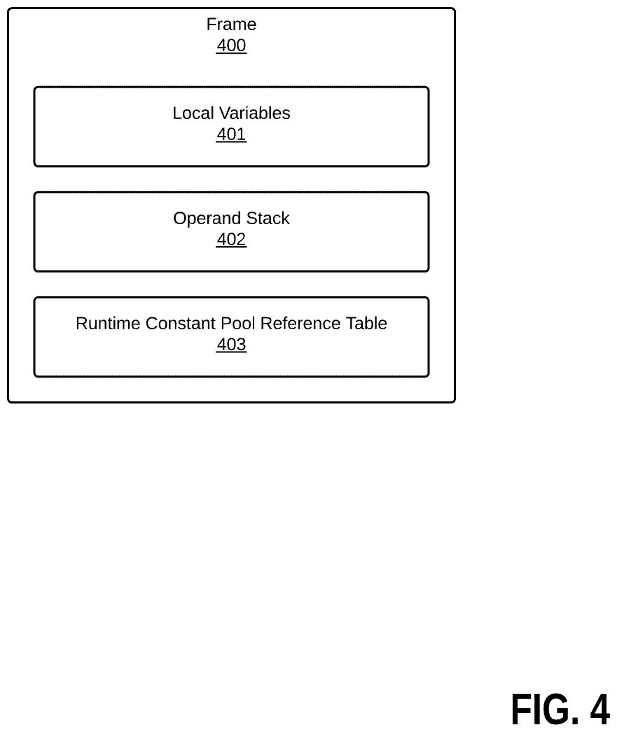

FIG. 4 illustrates an example frame 400 in block diagram form according to an embodiment. In order to provide clear examples, the remaining discussion will assume that frames of virtual machine stack 310 and virtual machine stack 313 adhere to the structure of frame 400.

In an embodiment, frame 400 includes local variables 401, operand stack 402, and runtime constant pool reference table 403. In an embodiment, the local variables 401 are represented as an array of variables that each hold a value, for example, Boolean, byte, char, short, int, float, or reference. Further, some value types, such as longs or doubles, may be represented by more than one entry in the array. The local variables 401 are used to pass parameters on method invocations and store partial results. For example, when generating the frame 400 in response to invoking a method, the parameters may be stored in predefined positions within the local variables 401, such as indexes 1-N corresponding to the first to Nth parameters in the invocation.

In an embodiment, when the frame 400 is created by the virtual machine 104, the operand stack 402 is empty by default. The virtual machine 104 then supplies instructions from the method code 305 of the current method to load constants or values from the local variables 401 onto the operand stack 402. Other instructions take operands from the operand stack 402, operate on them, and push the result back onto the operand stack 402. Furthermore, the operand stack 402 is used to prepare parameters to be passed to methods and to receive method results. For example, the parameters of the method being invoked could be pushed onto the operand stack 402 prior to issuing the invocation to the method. The virtual machine 104 then generates a new frame for the method invocation where the operands on the operand stack 402 of the previous frame are popped and loaded into the local variables 401 of the new frame. When the invoked method terminates, the new frame is popped from the virtual machine stack and the return value is pushed onto the operand stack 402 of the previous frame.

In an embodiment, the runtime constant pool reference table 403 contains a reference to the runtime constant pool 304 of the current class. The runtime constant pool reference table 403 is used to support resolution. Resolution is the process whereby symbolic references in the constant pool 304 are translated into concrete memory addresses, loading classes as necessary to resolve as-yet-undefined symbols and translating variable accesses into appropriate offsets into storage structures associated with the runtime location of these variables.

### 2.3 Loading, Linking, and Initializing

In an embodiment, the virtual machine 104 dynamically loads, links, and initializes classes. Loading is the process of finding a class with a particular name and creating a representation from the associated class file 200 of that class within the memory of the runtime environment 113. For example, creating the representation from the associated class file 200 may include creating the runtime constant pool 304, method code 305, and field and method data 306 for the class within the per-class area 303 of the virtual machine memory layout 300. Linking is the process of taking the in-memory representation of the class and combining it with the runtime state of the virtual machine 104 so that the methods of the class can be executed. Initialization is the process of executing the class constructors to set the starting state of the field and method data 306 of the class and/or create class instances on the heap 302 for the initialized class.

The following are examples of loading, linking, and initializing techniques that may be implemented by the virtual machine 104. However, in many embodiments the steps may be interleaved, such that an initial class is loaded, then during linking a second class is loaded to resolve a symbolic reference found in the first class, which in turn causes a third class to be loaded, etc. Thus, progress through the stages of loading, linking, and initializing can differ from class to class. Furthermore, some embodiments may delay (perform “lazily”) one or more functions of the loading, linking, and initializing process until the class is required. For example, resolution of a method reference may be delayed until a virtual machine instruction invoking the method is executed. Thus, the exact timing of when the steps are performed for each class can vary greatly between implementations.

To begin the loading process, the virtual machine 104 invokes the class loader 107 which loads an initial class. The technique by which the initial class is specified will vary from embodiment to embodiment. For example, one technique may have the virtual machine 104 accept a command line argument on startup that specifies the initial class.

To load a class, the class loader 107 parses the class file 200 corresponding to the class and determines if the class file 200 is well-formed (meets the syntactic expectations of the virtual machine 104). If not, the class loader 107 generates an error. For example, in Java the error might be generated in the form of an exception which is thrown to an exception handler for processing. Otherwise, the class loader 107 generates the in-memory representation of the class by allocating the runtime constant pool 304, method code 305, and field and method data 306 for the class within the per-class area 303.

In some embodiments, when the class loader 107 loads a class, the class loader 107 also recursively loads the super-classes of the loaded class. For example, the virtual machine 104 may ensure that the super-classes of a particular class are loaded, linked, and/or initialized before proceeding with the loading, linking and initializing process for the particular class.

During linking, the virtual machine 104 verifies the class, prepares the class, and resolves the symbolic references defined in the runtime constant pool 304 of the class.

To verify the class, the virtual machine 104 checks if the in-memory representation of the class is structurally correct. For example, the virtual machine 104 may check that each class except the generic class Object has a superclass, check that final classes have no sub-classes and final methods are not overridden, check if constant pool entries are consistent with one another, check if the current class has correct access permissions for classes/fields/structures referenced in the constant pool 304, check that the virtual machine 104 code of methods will not cause unexpected behavior (e.g. making sure a jump instruction does not send the virtual machine 104 beyond the end of the method), etc. The exact checks performed during verification are dependent on the implementation of the virtual machine 104. In some cases, verification may cause additional classes to be loaded, but does not necessarily require those classes to also be linked before proceeding. For example, assume Class A contains a reference to a static field of Class B. During verification, the virtual machine 104 may check Class B to ensure that the referenced static field actually exists, which might cause loading of Class B, but not necessarily the linking or initializing of Class B. However, in some embodiments, certain verification checks can be delayed until a later phase, such as being checked during resolution of the symbolic references. For example, some embodiments may delay checking the access permissions for symbolic references until those references are being resolved.

To prepare a class, the virtual machine 104 initializes static fields located within the field and method data 306 for the class to default values. In some cases, setting the static fields to default values may not be the same as running a constructor for the class. For example, the verification process may zero out or set the static fields to values that the constructor would expect those fields to have during initialization.

During resolution, the virtual machine 104 dynamically determines concrete memory address from the symbolic references included in the runtime constant pool 304 of the class. To resolve the symbolic references, the virtual machine 104 utilizes the class loader 107 to load the class identified in the symbolic reference (if not already loaded). Once loaded, the virtual machine 104 has knowledge of the memory location within the per-class area 303 of the referenced class and its fields/methods. The virtual machine 104 then replaces the symbolic references with a reference to the concrete memory location of the referenced class, field, or method. In an embodiment, the virtual machine 104 caches resolutions to be reused in case the same class/name/descriptor is encountered when the virtual machine 104 processes another class. For example, in some cases, class A and class B may invoke the same method of class C. Thus, when resolution is performed for class A, that result can be cached and reused during resolution of the same symbolic reference in class B to reduce overhead.

In some embodiments, the step of resolving the symbolic references during linking is optional. For example, an embodiment may perform the symbolic resolution in a “lazy” fashion, delaying the step of resolution until a virtual machine instruction that requires the referenced class/method/field is executed.

During initialization, the virtual machine 104 executes the constructor of the class to set the starting state of that class. For example, initialization may initialize the field and method data 306 for the class and generate/initialize any class instances on the heap 302 created by the constructor. For example, the class file 200 for a class may specify that a particular method is a constructor that is used for setting up the starting state. Thus, during initialization, the virtual machine 104 executes the instructions of that constructor.

In some embodiments, the virtual machine 104 performs resolution on field and method references by initially checking if the field/method is defined in the referenced class. Otherwise, the virtual machine 104 recursively searches through the super-classes of the referenced class for the referenced field/method until the field/method is located, or the top-level superclass is reached, in which case an error is generated.

### 3. STREAM DATA PARSING SYSTEM

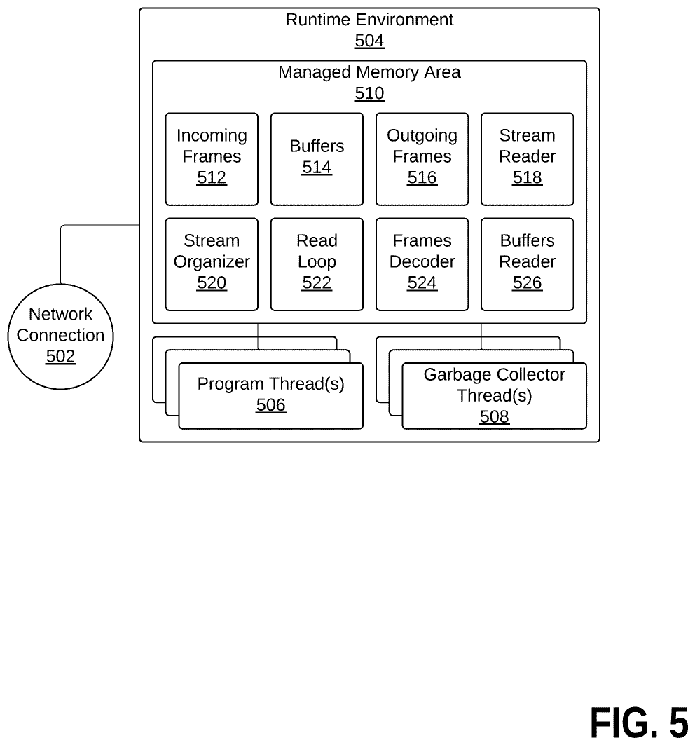

FIG. 5 illustrates a system 500 for practicing techniques described herein in accordance with one or more embodiments. As illustrated in FIG. 5, system 500 includes network connection 502 and runtime environment 504. In one or more embodiments, the system 500 may include more or fewer components than the components illustrated in FIG. 5. The components illustrated in FIG. 5 may be local to or remote from each other. The components illustrated in FIG. 5 may be implemented in software and/or hardware. Each component may be distributed over multiple applications and/or machines. Multiple components may be combined into one application and/or machine. Operations described with respect to one component may instead be performed by another component.

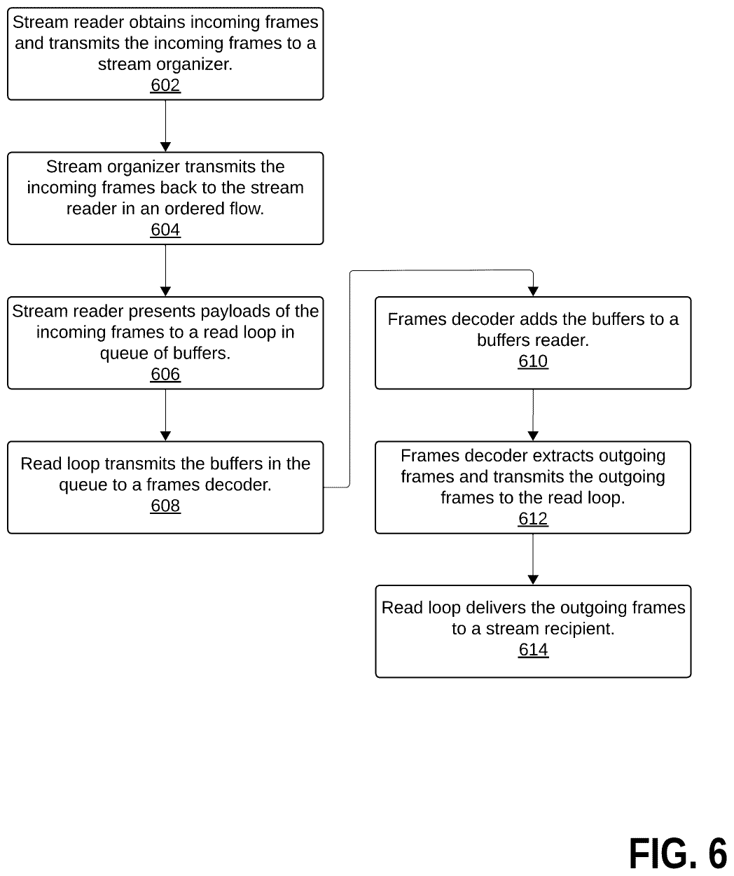

In one or more embodiments, system 500 refers to hardware and/or software configured to perform operations described herein for parsing stream data of one or more data streams. For brevity, a data stream may be referred to herein simply as a “stream.” Example operations for parsing stream data are described below with reference to FIG. 6. Additional embodiments and/or examples relating to parsing stream data are described within R01338NP, R01338N2, and R01338N3. The disclosures set forth by R01338NP, R01338N2, and R01338N3 are incorporated by reference in entirety as if set forth herein.

In an embodiment, network connection 502 is one or more network links of a communication network that is coupled to system 500. Network connection 502 delivers information to system 500, and/or network connection 502 transmits information from system 500. Network connection 502 includes physical link(s), and/or network connection 502 includes wireless link(s). The communication network that includes network connection 502 may be conceptualized in terms of layers of abstraction that model the flow of information within the communication network. As an example, consider the Open Systems Interconnection (OSI) model. The OSI model defines seven network layers. From lowest to highest, the seven network layers of the OSI model are (1) the physical layer, (2) the data link layer, (3) the network layer, (4) the transport layer, (5) the session layer, (6) the presentation layer, and (7) the application layer. For brevity, a layer of abstraction may be referred to herein simply as a “layer.”

In an embodiment, network connection 502 communicatively couples system 500 to at least one source of stream data. A source of stream data is local to a component of system 500, and/or a source of stream data is remote from a component of system 500. Furthermore, a source of stream data is located at the same physical site as a component of system 500, and/or a source of stream data is located a different physical site than a component of system 500. A source of stream data may be a component of system 500.

In an embodiment, network connection 502 is configured to transmit stream data in accordance with a single communication protocol, or network connection 502 is configured to transmit stream data system 500 in accordance with multiple communication protocols. For brevity, a communication protocol may be referred to herein simply as a “protocol.” Some protocols permit multiple streams to be established through a single network connection. Accordingly, depending on the protocol(s) associated with network connection 502, a single stream can be established through network connection 502, or multiple streams can be established through network connection 502.

In an embodiment, a protocol applicable to network connection 502 is associated with a single layer of a communication network that includes network connection 502, or the protocol is associated with multiple layers of the communication network. As used herein, the term “lower-layer protocol” refers to a protocol that is associated with lower-layer(s) of a communication network, and the term “higher-layer protocol” refers to a protocol that is associated with higher layer(s) of a communication network. In the context of the OSI model, for example, a lower-layer protocol is any communication protocol associated with at least one protocol that is not an application-layer protocol, and a higher-layer protocol is any protocol associated with at least one network layer that is not a physical-layer protocol. Network connection 502 may transmit stream data in accordance with physical-layer protocols, data-link-layer protocols, network-layer protocols, transport-layer protocols, session-layer protocols, presentation-layer protocols, application-layer protocols, and/or other protocols.

In an embodiment, network connection 502 is configured to transmit protocol frames to system 500, and/or network connection 502 is configured to transmit protocol frames from system 500. A frame pushed onto a virtual machine stack (e.g., virtual machine stack 310 or virtual machine stack 313) is distinct from a protocol frame. For brevity, a protocol frame may be referred to herein simply as a “frame.” Depending on the protocol(s) applicable to network connection 502, the frames transmitted through network connection 502 may be delivered to system 500 packaged within other units of stream data. In an example, network connection 502 delivers packets that are formatted according to one protocol, and these packets embed other packets that are formatted according to another protocol that is built on top of the one protocol. The other packets in this example embed frames that are formatted according to the other protocol. A protocol may define multiple types of frames that serve various purposes, and the protocol may specify different formats for the different frame types. Example frame types that may be defined by a protocol include authentication frames, data frames, connection control frames, acknowledgement frames, flow control frames, error control frames, management frames, handshake frames, synchronization frames, and others. A format for a frame that is specified by a protocol may dictate that the frame include a header, a payload, padding, a footer, and/or other components. If a frame includes a header, the header typically encodes frame metadata. For example, a header of a frame may specify a frame type, a stream ID, a frame offset, a frame length, and/or other information. In this example, the stream ID of the frame identifies a stream that the frame belongs to. The frame offset of the frame in this example indicates the position of the frame's payload within a stream, and the frame length of the frame indicates the size of the payload. One type of frame may carry a payload, and another type of frame may not carry a payload. A payload of a frame may carry other units of stream data. For example, the payloads of frames formatted according to one protocol (e.g., a lower-layer protocol) may encode other frames that are formatted according to another protocol (e.g., a higher-layer protocol).

In an embodiment, runtime environment 504 is a computing environment for executing one or more program instances. Runtime environment 504 provides resources for running program instance(s) and/or other processes that support the proper functioning of the program instance(s) and the wider runtime environment 504. Runtime environment 504 includes processing resources, and runtime environment 504 includes memory resources. As illustrated in FIG. 5, runtime environment 504 may include program thread(s) 506, garbage collector thread(s) 508, and managed memory area 510. An example runtime environment 504 typically includes various other resources that are not illustrated in FIG. 5.

In an embodiment, runtime environment 504 is implemented in the context of one or more class-based, object-oriented programming languages. Examples of class-based, object-oriented programming languages include Java, C++, C#, Python, Ruby, and others. The implementation of runtime environment 504 in the context of class-based, object-oriented program language(s) is described herein for illustrative purposes and is not intended to define any limits to the disclosure. The techniques described herein are equally applicable to other computing environments and other programming languages.

In an embodiment, program thread(s) 506 and garbage collector thread(s) 508 are threads of execution. A thread of execution is an independent execution environment for machine-level instructions. The runtime environment 504 of this embodiment includes multiple threads, or the runtime environment 504 includes a single thread. A thread may be a program thread 506 at one moment, and the thread may be a garbage collector thread 508 at another moment. A typical implementation of the Java Runtime Environment is one example of a multi-thread computing environment, and a typical implementation of the Java Card Runtime Environment is one example of a single-thread computing environment. A multi-thread computing environment is an example of a computing environment that is capable of performing concurrent operations. The implementation of runtime environment 504 as a threaded computing environment is described herein for illustrative purposes and is not intended to define any limits to this disclosure. The techniques described herein are equally applicable to other computing architectures.

In an embodiment, a program thread 506 is a thread of execution that is currently performing operations at the behest of a program instance. A program thread 506 is often manipulating information residing in managed memory area 510 while executing machine-level instructions associated with a program instance. For instance, while completing the requests of a program, a program thread 506 may be creating new data structures within managed memory area 510, reading from data structures residing in managed memory area 510, writing to data structures residing in managed memory area 510, and/or performing various other operations within managed memory area 510. An example program instance that is executed, at least in part, by a program thread 506 is configured to parse stream data delivered to system 500 through network connection 502.

In an embodiment, a garbage collector thread 508 is a thread of execution that is currently performing operations at the behest of a garbage collection process. As used herein, the term “garbage collection” refers to memory management. In the example context of runtime environment 504, a garbage collection process may be configured to reclaim memory allocated to data structures residing within managed memory area 510 that are no longer needed by a currently executing program instance. For instance, a garbage collector thread 508 may reclaim memory space allocated to data structures that were previously being used by a program instance to buffer stream data delivered to system 500 through network connection 502.

In an embodiment, managed memory area 510 is a data repository that serves, at least in part, as runtime memory for one or more program instances. In addition to including information that can be manipulated by a program instance, managed memory area 510 may include information that is not exposed at a program-level. A data repository is any type of storage unit and/or device (e.g., a file system, database, collection of tables, or any other storage mechanism) for storing data. Furthermore, a data repository may include multiple different storage units and/or devices. The multiple different storage units and/or devices of a data repository may or may not be of the same type or located at the same physical site. A data repository may be implemented in volatile memory, and/or the data repository may be implemented in persistent memory.

In an embodiment, information is represented within managed memory area 510 by runtime objects. A runtime object is a data structure that exists in memory while a program instance is currently executing. Generally, a runtime object is an abstraction of binary data that resides somewhere in low-level memory. For example, a runtime object may be an abstraction of binary data stored to main memory (e.g., random access memory). In the example illustrated by FIG. 3, a managed memory area 510 may be implemented within heap 302. In this example, the managed memory area 510 will typically include various other runtime objects that are not represented in FIG. 5. Managed memory area 510 is “managed” in the sense that managed memory area 510 may be subjected to a garbage collection process during runtime. For instance, an example garbage collection process is configured to reclaim memory space allocated to runtime objects residing in managed memory area 510. The example garbage collection process deems memory space allocated to a runtime object eligible for reclamation if that runtime object has become less than strongly reachable. A runtime object is strongly reachable if there is a chain of strong reference(s) that can be traversed by a program thread 506 to access that runtime object. In contrast, if there is no chain of strong reference(s) that can be traversed by a program thread 506 to access a runtime object, that runtime object is not strongly reachable. A runtime object being less than strongly reachable to a program thread 506 does not necessarily imply that the runtime object is unreachable to a program thread 506. For example, a runtime object that is not strongly reachable may remain reachable through a non-strong reference. An example strong reference is a default reference that is typically used to refer to a runtime object. An example non-strong reference is a special type of reference that is created by a reference object (e.g., a soft reference object, a weak reference object, a final reference object, a phantom reference object, a native weak reference object, etc.). Furthermore, the term “unreachable” is not necessarily synonymous with the term “inaccessible.” For example, a runtime object that is unreachable to a program thread 506 may remain accessible to a garbage collector thread 508. As used herein, the term “disposable” identifies information that is eligible for garbage collection, and the term “live” identifies information that is ineligible for garbage collection. A runtime object may provide access to a method that is defined by a reference type that is related to the runtime object. A runtime object may be described herein as performing an operation if a method (e.g., an instance method, a static method, etc.) defined by a related reference type is executed. As an example, consider an instance of a class that defines a method for writing to an object field, and assume that the method is called on the class instance. In this example, the class instance is said to “write to an object field” when a thread executes machine-level instructions corresponding to the operations defined in the method body of the method. A method need not be invoked for that method to be executed. If a method is invoked, the method is invoked explicitly, or the method is invoked implicitly.

In an embodiment, managed memory area 510 includes mechanisms for parsing stream data, and/or managed memory area 510 includes other information. As illustrated in FIG. 5, managed memory area 510 may include incoming frames 512, buffers 514, outgoing frames 516, stream reader 518, stream organizer 520, read loop 522, frames decoder 524, and/or buffers reader 526. Information describing incoming frames 512, buffers 514, outgoing frames 516, stream reader 518, stream organizer 520, read loop 522, frames decoder 524, and/or buffers reader 526 may be implemented across any of the components within system 500 (components illustrated in FIG. 5 and otherwise) (e.g., a per-class area, a virtual machine stack, local variables, an operand stack, etc.). However, this information is depicted by FIG. 5 solely within the bounds of managed memory area 510 for purposes of clarity and explanation.

In an embodiment, an incoming frame 512 is a protocol frame that represents stream data received by system 500 through network connection 502. An incoming frame 512 may be delivered to the system 500 as binary stream data that is formatted according to a protocol, and the incoming frame 512 may subsequently be manifested in managed memory area 510 as a higher-level abstraction of that binary data that is formatted according to a reference type. An incoming frame 512 is associated with a single protocol, or the incoming frame 512 is associated with multiple protocols. An incoming frame 512 may be associated with a lower-layer protocol, a higher-layer protocol, and/or another variety of communication protocol.

In an embodiment, an incoming frame 512 is associated with a lower-layer protocol. For instance, an incoming frame 512 may be associated with a transport-layer protocol. Example transport-layer protocols that may be associated with an incoming frame 512 include the following: the Transmission Control Protocol (TCP), the User Datagram Protocol (UDP), the QUIC Protocol, the Stream Control Transmission Protocol (SCTP), the Datagram Congestion Control Protocol (DCCP), the Reliable User Datagram Protocol (RUDP), and others. Recall that any given protocol may define different frame types that serve distinct purposes. Frame types of the QUIC Protocol, for example, include a stream frame, a crypto frame, a connection control frame, an acknowledgement frame, and others. The QUIC Protocol is built on top of the UDP, and the QUIC Protocol uses UDP to deliver the features of the QUIC Protocol. As an example, assume that a QUIC stream is established through network connection 502. In this example, network connection 502 may deliver datagrams to system 500. Datagrams are packets formatted according to the UDP. The UDP datagrams of this example embed other packets formatted according to the QUIC Protocol (i.e., QUIC packets). If a datagram embeds a QUIC packet in this example, the datagram embeds a single QUIC packet, or the datagram embeds multiple QUIC packets. The QUIC packets of this example may embed incoming frames 512 formatted according to the QUIC Protocol (i.e., QUIC frames). A QUIC packet of this example embeds a portion of a QUIC frame, a single QUIC frame, and/or multiple QUIC frames. In this example, the QUIC frames may, in turn, embed other frames that accord to a higher-layer protocol (e.g., an application-layer protocol). To provide consistent examples, the QUIC Protocol is used as an example at multiple points in this Detailed Description. These examples are provided for the reader's convenience and should not be interpreted as limiting the scope of one or more embodiments.

In an embodiment, an incoming frame 512 overlaps with another incoming frame 512. An incoming frame 512 is said to “overlap” with another incoming frame 512 if the data carried by that incoming frame 512 overlaps with the data carried by the other incoming frame 512. For example, if the payload of one incoming frame 512 carries stream data that also appears, at least in part, in the payload of another incoming frame 512, the one incoming frame 512 is said to overlap with the other incoming frame 512. Overlapping incoming frames 512 can be identified based on frame metadata. For example, the system 500 may identify two overlapping incoming frames 512 based on a comparison between the two incoming frames' (a) stream IDs, (b) frame offsets, and/or (c) frame lengths (e.g., by comparing frame offsets and frame lengths). The frame metadata that is used by the system 500 to identify overlaps between incoming frames 512 may vary depending on the protocol associated with the incoming frames 512, the frame type of the incoming frames 512, and other factors. If two incoming frames 512 partially overlap with one another, the system 500 may deem one of those two incoming frames 512 partially extraneous. The term “extraneous” is used herein to refer generally to any information that is redundant, unwanted, unneeded, outdated, or otherwise surplus to the intended purpose, context, or operation of the system.

In an embodiment, an incoming frame 512 is a duplicate of another incoming frame 512. Incoming frames 512 are referred to as “duplicates” if those incoming frames share at least some identical attributes. For example, an incoming frame 512 is referred to as a “duplicate” of another incoming frame 512 if both incoming frames 512 deliver the same payload. A duplicate incoming frame 512 need not be a frame that carries a payload. Duplicate incoming frames 512 can be identified based on frame metadata. For example, two incoming frames 512 that carry the same payload will specify the same stream ID, frame offset, and frame length. If two incoming frames 512 are duplicates of one another, the system 500 may deem one of those two incoming frames 512 fully extraneous.

In an embodiment, an incoming frame 512 is manifested in managed memory area 510 as a runtime object that is related to an incoming frames reference type. For instance, an incoming frame 512 may be manifested as an instance of an incoming frames class, or the incoming frame 512 may be manifested as an instance of a subclass that directly or indirectly extends the incoming frames class. Additionally, or alternatively, an incoming frame 512 may be manifested as an instance of a class that directly or indirectly implements an incoming frames interface. As an example, assume that an incoming frame 512 received through network connection 502 is a QUIC frame. The QUIC frame of this example is, more specifically, a stream frame that delivers a payload of stream data. In this example, the stream frame is manifested in managed memory area 510 as an instance of a stream frame class that extends a QUIC frames class (i.e., an incoming frames reference type). An incoming frame's 512 manifestation as a runtime object generally includes object field(s) that hold frame metadata. The frame metadata carried by object fields of an incoming frame may correspond to binary data that is carried by the header of that incoming frame 512. For example, the object fields of an incoming frame 512 may hold a frame type, a stream ID, a frame offset, a frame length, and/or other information. Additionally, or alternatively, frame metadata held by object fields of an incoming frame 512 may be derived from other sources of information, such as other incoming frames 512 that are constituents of the same stream, a packet that encapsulates the incoming frame 512, and so on. An incoming frames reference type may vary depending on the protocol(s) associated with the incoming frame 512, the frame type of the incoming frame 512 (e.g., an authentication frame, a frame carrying a payload of stream data, a connection control frame, etc.), and/or other factors. Accordingly, the object fields, instance methods, and other aspects of a runtime object manifesting an incoming frame 512 may also vary.

In an embodiment, a buffer 514 is an abstraction that serves as a mechanism for storing information in memory. For instance, a buffer 514 may act as a mechanism for storing stream data in memory, and/or the buffer 514 may serve as a mechanism for holding other information in memory. A buffer 514 may be configured to act as a storage mechanism for a specific primitive data type. Example buffers 514 include byte buffers 514, char buffers 514, double buffers 514, float buffers 514, int buffers 514, long buffers 514, short buffers 514, and others. In general, a buffer 514 is configured to provide other components of system 500 access to a dataset that is presented by the buffer 514.

In an embodiment, a buffer 514 is an abstraction that is backed by an underlying data structure, and the underlying data structure may, in turn, be backed by even lower-level data structures. An array is an example of an underlying data structure that may back a buffer 514. When a dataset is “stored” to a buffer 514, the binary data encoding that dataset is, in actuality, being stored to the underlying data structure that is backing the buffer 514. For example, when binary data is stored to a byte buffer 514, that binary data may be encoded into an underlying byte array that backs the buffer 514. An underlying data structure that backs a buffer 514 may reside in managed memory area 510, or the underlying data structure that backs a buffer 514 may reside outside of managed memory area 510 (e.g., in native memory).

In an embodiment, a buffer 514 provides methods for accessing data stored to the buffer 514. As an example, consider a byte buffer 514 that is backed by a byte array. In this example, the byte buffer 514 may provide methods for retrieving information from the byte array, writing to the byte array, clearing the byte array, modifying the byte order of the byte array, and performing other operations.

In an embodiment, a buffer 514 is backed by an underlying data structure, and the buffer 514 indexes elements that are both (a) included within the underlying data structure and (b) represented by the buffer 514. An example buffer 514 indexes elements starting from zero. As used herein, the term “element” refers herein to some unit of data. Example elements that may be indexed by a buffer 514 include bits, bytes, characters, integers, floats, shorts, longs, custom elements, and others. A data structure that backs a buffer 514 may include elements that are not represented by the buffer 514, and the data structure may index elements differently than the buffer 514. The location of an element with respect to the indexing of a buffer 514 that represents the element is referred to herein as the “relative position” of the element, and the location of an element with respect to the indexing of an underlying data structure that backs the buffer 514 and stores the element is referred to herein as the “local position” of the element. A difference between the relative position of an element and the local position of the element is referred to herein as an “array offset.” The relative position of an element represented by a buffer 514 is equal to the local position of that element plus the array offset.

In an embodiment, a buffer 514 maintains variable(s) that characterize (a) the buffers 514 and/or (b) elements represented by the buffers 514. Example variables that may be maintained by a buffers 514 include (a) an array offset, (b) a read position, (c) a limit, (d) a capacity, and (c) others. An array offset of a buffer 514 is specified with respect to the indexing of an array that backs the buffer 514. In other words, an array offset indicates the distance between the starting point of an array backing a buffer 514 and the first element represented by that buffer 514. If the array offset is zero, the indexing of the array will coincide with the indexing of the example buffer 514; however, if the array offset is a non-zero value, the indexing of the example buffer 514 will be staggered from the indexing of the array. The read position of a buffer 514 is the relative position of the element that should be read next. The limit of a buffer 514 is the relative position of the first element that should not be accessible through the buffer 514. For example, if the limit of a buffer 514 is five, the last element that should be accessible through the buffer 514 has a relative position of four. The capacity of the buffer 514 is the number of elements that are represented by the buffer 514. An element represented by a buffer 514 may be read, or the element may be unread. An element is referred to herein as a “read element” if the relative position of that element is less than the read position of a buffer 514 that represents that element. A buffer 514 is referred to herein as “fully read” if the buffer 514 does not represent any unread elements. For example, a buffer 514 is fully read if the read position of the buffer 514 matches the limit of the buffer 514. A buffer 514 is referred to herein as “partially read” if (a) at least one element represented by the buffer 514 has been read and (b) at least one element represented by the buffer 514 has not been read. As an example, assume that a buffer 514 indexes elements represented by the buffer 514 starting from zero. In this example, the buffer 514 is partially read if the read position of the buffer 514 is both (a) greater than zero and (b) less than the limit of the buffer 514. A buffer 514 is referred to herein as “fully unread” if no elements represented by the buffer 514 have been read (e.g., the read position of the buffer 514 is zero).

In an embodiment, a buffer 514 offers getter methods that are configured to return variables of the buffer 514. For instance, among other methods, an example buffer 514 offers a “position” method and a “limit” method. The position method of the example buffer 514 returns the read position of the example buffer 514, and the limit method of the example buffer 514 returns the limit of the example buffer 514. It should be noted that the example buffer 514 offers separate setter methods having these same names (i.e., “position” and “limit”) that can be used to alter the read position and limit of the example buffer 514. In addition, a buffer 514 may provide method(s) that determine other attributes of the buffer 514 based on variables maintained by the buffer 514. For instance, the example buffer 514 offers a “has remaining” method and a “remaining” method. The has remaining method of the example buffer 514 is a Boolean method that returns true if the example buffer 514 represents at least one unread element. The remaining method of the example buffer 514 is an integer method that returns the number of unread elements represented by the example buffer 514.

In an embodiment, a buffer 514 provides method(s) for reading element(s) represented by the buffer 514. As used herein, the phrase “reading through a buffer” 514 refers to retrieving element(s) represented by the buffer 514 and recording those element(s) as being read. An example buffer 514 (e.g., a byte buffer) offers a relative “get” method that can be used to read from the buffer 514. If the relative get method is invoked, the relative get method is configured to (a) return the element (e.g., a byte) that resides at the read position of the example buffer 514 and (b) increment the read position of the example buffer 514 by one element (e.g., one byte). The example buffer 514 may provide multiple relative get methods. For instance, the example buffer 514 may also provide a relative get method that can be used to read multiple elements.

In an embodiment, a buffer 514 offers method(s) for peeking elements represented by the buffer 514. As used herein, the phrase “pecking through a buffer” 514 refers to retrieving element(s) represented by the buffer 514 without recording those element(s) as being read. An example buffer 514 provides absolute “get” method(s) that can be used to peck through the example buffer 514. Executing an absolute get method of the example buffer 514 does not alter a read position of the example buffer 514.

In an embodiment, a buffer 514 offers setter methods for altering variables maintained by the buffer 514. For instance, among other methods, an example buffer 514 provides a “position” method for setting the read position of the example buffer 514 to a relative position that is specified as an input parameter, and the example buffer 514 provides a “limit” method for altering the limit of the example buffer 514 to a relative position specified as an input parameter.

In an embodiment, a buffer 514 provides method(s) for creating a new buffer 514. For example, a byte buffer 514 may provide methods for slicing the byte buffer object to create a new byte buffer 514, allocating a new byte buffer 514, duplicating the byte buffer 514, and performing other operations. An example slice method of a buffer 514 creates a new buffer 514 that is a shared subsequence of the buffer's 514. In other words, the example slice method creates a new buffer 514 that is backed by the same underlying data structure (e.g., a byte array object) as the original buffer 514. In contrast, an example allocate method of a buffer 514 can be used to create a new buffer 514 that is backed by a separate underlying data structure.

In an embodiment, a buffer 514 is a runtime object that is related to a buffer reference type. As an example, consider a byte buffer 514. In this example, the buffer reference type is a buffer class, and the byte buffer 514 is an instance of a byte buffer class that extends the buffer class. In this example, the byte buffer 514 may be backed by a byte array that is represented in managed memory are 510 by an array object. The buffer class also possesses other subclasses for other types of buffers 514 in this example.

In an embodiment, a buffer 514 stores the payload of an incoming frame 512. More specifically, a payload of an incoming frame 512 is stored to an underlying data structure that backs a buffer 514, and the buffer 514 serves as the payload's representation in managed memory area 510. An incoming frame's 512 payload is often the majority of the data that is delivered by the incoming frame 512; accordingly, the majority of the memory space that describes an incoming frame 512 may be allocated to the underlying data structure that store's the incoming frame's 512 payload.

In an embodiment, a buffer 514 serving as a representative of an incoming frame's 512 payload offers method(s) that can be used to manipulate the data delivered within the payload. For instance, if the payload of an incoming frame 512 is partially extraneous, that payload may be sliced or partitioned by calling a method on a representative buffer 514. Creating a new data item that includes part of another data item is referred to herein as “slicing” the other data item if the new data item is a shared subsequence of the other data item. Creating a new data item that includes part of another data item is referred to herein as “partitioning” the other data item if the new data item is created by copying that part of the other data item to another location in memory. As an example, assume that an incoming frame 512 delivers a payload of partially extraneous binary stream data to the system 500. In this example, the incoming frame's 512 payload is stored to a byte array that backs a byte buffer 514, and the byte buffer 514 represents the incoming frame's payload in managed memory area 510. The payload of this example can be sliced by calling a slice method on the byte buffer 514, and the payload can be partitioned by calling an allocate method on the byte buffer 514. Calling the slice method on the byte buffer 514 in this example may result in the creation of a new byte buffer 514 that is backed by the same byte array as the original byte buffer 514. In comparison, calling the allocate method on the byte buffer 514 in this example may result in the creation of a new byte buffer 514 that is backed by a newly allocated byte array. Different parts of a protocol frame may be stored in different sections of memory. As an example, consider an incoming frame 512 that delivers a payload. The payload of this example is represented by a buffer 514 that is backed by an underlying data structure storing the payload. In this example, the incoming frame 512 (i.e., a runtime object representing a protocol frame in managed memory 510) may be stored in a different section of memory than the buffer 514 and/or the payload. The phrase “slicing a protocol frame” may refer herein to slicing any part of that protocol frame. For example, calling a slice method on a buffer 514 that stores an incoming frame's 512 payload may be referred to as “slicing the incoming frame 512” even though the incoming frame 512 may be described in a section of memory that is separate from the section of memory that describes the payload. Similarly, partitioning any part of a protocol frame may be referred to as “partitioning that protocol frame.” For example, calling an allocate method on a buffer 514 that represent an incoming frame's 512 payload may be referred to herein as “partitioning the incoming frame 512.”

In an embodiment, an outgoing frame 516 includes stream data delivered by system 500 to a stream recipient. A stream recipient may reside within runtime environment 504, or a stream recipient may reside outside of runtime environment 504. A stream recipient is local to a component of system 500, and/or a stream recipient is remote from a component of system 500. A stream recipient is located at the same physical site as a component of system 500, and/or a stream recipient is located at a different physical site than a component of system 500. An outgoing frame 516 is associated with a single protocol, or an outgoing frame 516 is associated with multiple protocols. An outgoing frame 516 may be associated with lower-layer protocols, higher-layer protocols, and/or other protocols. In an example, an outgoing frame 516 is an incoming frame 512. In another example, an outgoing frame 516 is decoded from the payload of an incoming frame 512. If an outgoing frame 516 is delivered to system 500 embedded in other units of stream data, that outgoing frame 516 may be arbitrarily divided between multiple units of stream in a manner that will vary depending on the protocols involved in delivering that outgoing frame 516 to system 500.

In an embodiment, an outgoing frame 516 is associated with a higher-layer protocol (i.e., the outgoing frame 516 is a higher-layer frame). For instance, an outgoing frame 516 may be associated with an application-layer protocol. Example application-layer protocols that may be associated with an outgoing frame 516 include Hypertext Transfer Protocol (HTTP) (e.g., HTTP/1.0, HTTP/1.1, HTTP/2, HTTP/3, etc.), Hypertext Transfer Protocol Secure (HTTPS), File Transfer Protocol (FTP), Simple Mail Transfer Protocol (SMTP), Post Office Protocol version 3 (POP3), Internet Message Access Protocol (IMAP), Dynamic Host Configuration Protocol (DHCP), Domain Name System (DNS), Telnet, Secure Shell (SSH), Simple Network Management Protocol (SNMP), and others. In an example, outgoing frames 516 are HTTP/3 frames that are delivered to system 500 encoded into the payloads of QUIC stream frames (i.e., incoming frames 512). In this example, an HTTP/3 frame is embedded into a single QUIC stream frame, or the HTTP/3 frame is embedded into multiple QUIC stream frames. Upon delivery to system 500 in this example, the HTTP/3 frame is stored to a single buffer 514 (e.g., a byte buffer 514), or the HTTP/3 frame is stored to multiple buffers 514. To provide consistent examples, HTTP/3 is used as an example at multiple points in this Detailed Description. These examples are provided for the reader's convenience and should not be interpreted as limiting the scope of one or more embodiments.

In an embodiment, an outgoing frame 516 is manifested in managed memory area 510 as a runtime object that is related to an outgoing frame reference type. In an example, the outgoing frame reference type is an outgoing frame interface, and an outgoing frame 516 is manifested in managed memory area 510 as an instance of a class that directly or indirectly implements the outgoing frame interface. In another example, the outgoing frame reference type is an outgoing frame class, and an outgoing frame 516 is manifested in managed memory as an instance of a subclass that directly or indirectly extends the outgoing frame class. An outgoing frame's 516 manifestation as a runtime object may include object fields that hold frame metadata corresponding to binary data specified in a header of the outgoing frame 516 and/or another source of information. In general, the content of an outgoing frame 516 may vary depending on (a) a protocol associated with the outgoing frame 516, (b) a frame type of the outgoing frame 516, and/or (c) other factors.

In an embodiment, an outgoing frame 516 is related to an outgoing frame reference type, and the outgoing frame reference type offers method(s) that can be used to manipulate the outgoing frame 516. For example, the outgoing frame reference type may offer a static “decode” method that is configured to return an outgoing frame 516 that is decoded from a continuous sequence of elements presented by a buffers reader 526. The decode method of this example is configured to accept a buffers reader 526 and a predicate as input parameters. In this example, the predicate is a functional interface that is used by the decode method to determine if the frame type of an outgoing frame 516 presented by the buffers reader 526 is permissible. If the frame type of an outgoing frame 516 is permissible, the decode method of this example typically (a) returns the outgoing frame 516 modeled as a complete frame, (b) returns the outgoing frame 516 modeled as a partial frame, or (c) returns null if the continuous sequence of elements does not include sufficient information to decode the outgoing frame 516. If the frame type of an outgoing frame 516 is not permissible, the decode method of this example typically returns the outgoing frame 516 modeled as a malformed frame.

In an embodiment, an outgoing frame 516 is modeled as a complete frame. If an outgoing frame 516 is modeled as a complete frame, delivery of the outgoing frame 516 typically begins after the entirety of the outgoing frame 516 is decoded. Outgoing frames 516 that deliver fixed-length payloads are often modeled as complete frames. Examples of HTTP/3 frames that may be modeled as complete frames include (a) settings frames, (b) go away frames, (c) cancel push frames, (d) max push ID frames, and (c) others. In an example, an outgoing frame 516 is manifested in managed memory area 510 as a complete frame by an instance of a complete frame subclass that corresponds to the frame type of the outgoing frame 516. For instance, the complete frame subclass of this example may be (a) a settings frame subclass, (b) a go away frame subclass, (c) a cancel push frame subclass, (d) a max push ID frame subclass, or (c) another subclass. In this example, the complete frame subclass offers a static “decode frame” method that can be used to create a new complete frame of the frame type corresponding to the subclass. The decode frame method of this example accepts a buffers reader as an input parameter. If the decode frame method of this example is invoked, the decode frame method is configured to attempt to decode a new complete frame from a continuous sequence of elements presented by the buffers reader that was specified as an input parameter to the invocation of the decode frame method.

In an embodiment, an outgoing frame 516 is modeled as a partial frame. If an outgoing frame 516 is modeled as a partial frame, the system 500 may begin delivery of data included in the outgoing frame 516 before the outgoing frame 516 is fully decoded. Examples of HTTP/3 frames that may be modeled as partial frames include (a) headers frames, (b) data frames, (c) push promise frames, (d) HTTP/3 frames with unknown frame types, and (c) others. In an example, an outgoing frame 516 is manifested in managed memory area 510 as a partial frame by an instance of a partial frame subclass (i.e., a subclass of a partial frame class), and the partial frame subclass corresponds to the frame type of the partial frame. For instance, the partial frame subclass of this example may be (a) a headers frame subclass, (b) a data frame subclass, (c) a push promise frame subclass, (d) an unknown frame subclass, or (e) another partial frame subclass.

In an embodiment, an outgoing frame 516 is modeled as a partial frame, and the partial frame maintains variable(s) that track the state of the outgoing frame's 516 payload. As an example, assume that an outgoing frame 516 is encoded into bytes that are abstracted by byte buffer(s). In this example, the partial frame maintains a streaming length variable, a remaining variable, and/or other variables. The streaming length variable of this example measures the number of bytes that encode the outgoing frame's 516 payload, and the remaining variable of this example measures the number of bytes encoding the outgoing frame's 516 payload that have not yet been delivered to a stream recipient. In this example, the partial frame offers a “streaming length” method that is configured to return the value stored in the streaming length variable, and the partial frame offers a “remaining” method that is configured to return the value stored in the remaining variable. The partial frame of this example also offers a “next payload bytes” method that is configured to accepts a buffers reader 526 as an input parameter. In this example, the next payload bytes method of the partial frame is configured to return any bytes encoding payload data of the outgoing frame 516 that (a) have not already been delivered to a stream recipient and (b) are presently available for decoding. The next payload bytes of the partial frame of this example returns these bytes as a list of byte buffers that abstract these bytes. In addition, the next payload bytes method of this example is configured to update a read position of a buffers reader 526 to reflect the retrieval of any bytes that encode payload data of the outgoing frame 516.

In an embodiment, an outgoing frame 516 is modeled as an unknown frame. An unknown frame is a partial frame that models an outgoing frame 516 with an unknown frame type. In an example, the system determines if the frame type of an outgoing frame 516 is a known frame type by executing a static “for type” method that is offered by a frame type class while specifying the frame type of the outgoing frame 516 as an input parameter. In this example, the frame type class also offers a static “max length” method that can be invoked to determine a maximum length associated with a frame type. It should be noted that some protocols (e.g., HTTP/3) dictate that protocol frames with unknown frame types can be ignored; therefore, the payload of an outgoing frame 516 with an unknown frame type can safely be discarded in some scenarios. As used herein, the phrase “discarding a dataset” refers to rendering memory space allocated for storing that dataset eligible for reclamation. In an example, an outgoing frame 516 is manifested in managed memory area 510 as an unknown frame by an instance of an unknown frame class. In this example, the unknown frame class is a subclass of a partial frame class.

In an embodiment, an outgoing frame 516 is modeled as a malformed frame. An outgoing frame 516 may be modeled as a malformed frame if the outgoing frame 516 is found to possess some malformity. An example malformed frame includes (a) frame metadata of an outgoing frame 516 and (b) an error code indicating a malformity associated with the outgoing frame 516. A malformed frame can be used to trigger a protocol error that will (a) terminate a stream, (b) terminate a network connection that is used to establish the stream, and/or (c) cause other actions. In an example, an outgoing frame 516 is manifested in managed memory area 510 as a malformed frame as an instance of a malformed frame subclass.

In an embodiment, a stream reader 518 is a mechanism for processing incoming stream data. A stream reader 518 is configured to process incoming stream data by manipulating incoming frames 512, buffers 514, and/or other information. A stream reader 518 is configured for parsing incoming frames 512 associated with a particular protocol, or the stream reader 518 is configured for parsing incoming frames 512 that are associated with multiple protocols. A stream reader 518 is configured for parsing incoming frames 512 associated with a single stream, or the stream reader 518 is configured for parsing the incoming frames 512 of multiple streams. In an example, a stream reader 518 is configured to obtain incoming frames 512 from a remote peer, transmit the incoming frames 512 to a stream organizer 520, receive the incoming frames 512 transmitted back to the stream reader 518 by the stream organizer 520, present the payloads of incoming frames 512 in a queue of buffers 514, trigger a read loop 522 to consume the payloads presented in the queue of buffers 514, and perform other operations.

In an embodiment, a stream reader 518 is a runtime object that is related to a stream reader reference type. As an example, assume that incoming frames 512 are QUIC frames. In this example, a stream reader 518 is an instance of a QUIC receiver stream implementation class. The QUIC receiver stream implementation class of this example extends a QUIC stream class, and the QUIC stream class implements a QUIC receiver stream interface.

In an embodiment, a stream reader 518 maintains a queue of buffers 514. A queue of buffers 514 maintained by a stream reader 518 includes buffers 514 that store payloads of incoming frames 512. In particular, the buffers 514 listed in a queue of buffers 514 correspond to incoming frames 512 that the stream organizer 520 has transmitted back to the stream reader 518 in an ordered flow. In other words, the buffers 514 listed in this queue correspond to incoming frames 512 that the stream organizer 520 has released for further processing. In an example, a stream reader 518 organizes a queue of buffers 514 according to the same order that a stream organizer 520 transmits the corresponding incoming frames 512 back to the stream reader 518.

In an embodiment, a stream reader 518 provides methods for interacting with incoming frames 512, buffers 514, and other information. For example, a stream reader 518 may provide a method for processing incoming frames, a method for polling buffers 514 from an ordered queue of buffers 514 maintained by the stream reader 518, and other methods.

In an embodiment, stream organizer 520 is a mechanism for organizing stream data. Stream organizer 520 is configured to organize stream data by manipulating incoming frames 512 and/or other information. Stream organizer 520 is configured for parsing incoming frames 512 associated with a particular protocol, or stream organizer 520 is configured for parsing incoming frames 512 associated with multiple protocols. Stream organizer 520 is configured for parsing incoming frames 512 associated with a single stream, or stream organizer 520 is configured for parsing incoming frames 512 of multiple streams. In an example, a stream organizer 520 is configured to receive incoming frames 512 from a stream reader 518, and the stream organizer 520 is configured to transmit the incoming frames 512 back to the stream reader 518 in an ordered flow. The stream organizer 520 of this example is configured to organize the incoming frames 512 by reordering the incoming frames 512, discarding duplicate incoming frames 512, and eliminating overlaps between incoming frames 512.

In an embodiment, a stream organizer 520 provides methods for manipulating incoming frames 512, buffers 514, and/or other information. For example, a stream organizer 520 may provide a method for receiving incoming frames 512, a method for polling incoming frames 512 from the stream organizer 520 that the stream reader 518 may call to obtain any frame payload that is ready for delivery, a method for extracting frame offsets, a method for extracting frame lengths, a method for slicing incoming frames 512, a method for allocating new incoming frames 512, and other methods. A method of a stream organizer 520 may invoke another method on a buffer 514, an incoming frame 512, another runtime object, or a reference type (i.e., a static method). As an example, assume that a stream organizer 520 provides a slice method. The slice method of this example accepts one incoming frame 512 as an input parameter, and the slice method returns a new incoming frame 512 that can be used to replace the one incoming frame 512. In this example, calling the slice method on the stream organizer 520 may trigger the invocation of a slice method on a buffer 514 that represents a payload of the one incoming frame 512. The slice method of the buffer 514 will return a new buffer 514 that represents a portion of the one incoming frame's 512 payload, and the new incoming frame 512 will refer to the new buffer 514 in this example.

In an embodiment, stream organizer 520 offers a method that is configured to selectively replace incoming frames 512. In particular, the method is configured to generate a new incoming frame 512 to replace an existing incoming frame 512 if part of the data delivered to the system 500 by the existing incoming frame 512 is extraneous. There are multiple ways that a new incoming frame 512 can be created. Accordingly, the method offered by stream organizer 520 is configured to create a new incoming frame 512 in a manner that bests suits the present circumstances.

In an embodiment, a method of stream organizer 520 is configured to replace (a) an incoming frame 512 and buffer 514 that stores the incoming frame's 512 payload with (b) a new incoming frame 512 and a new buffer 514 that stores the new incoming frame's 512 payload. As an example, consider an original incoming frame 512 and an original buffer 514 that stores the original incoming frame's 512 payload. In this example, a method of stream organizer 520 instantiates a new incoming frame 512 to replace the original incoming frame 512, and the method of stream organizer 520 instantiates a new buffer 514 by either (a) slicing the original buffer 514 or (b) partitioning the original buffer 514. To slice the original buffer 514 in this example, the method of stream organizer 520 is configured to call a slice method on the original buffer 514. To partition the original buffer 514 in this example, the method of stream organizer 520 is configured to call an allocate method on the original buffer 514.

In an embodiment, a stream organizer 520 maintains an ordered queue of frames 512 and a flow offset. An ordered queue of frames 512 maintained by a stream organizer 520 holds incoming frames 512 that are not yet ready to be returned to a stream reader 518 for further processing. A flow offset tracked by a stream organizer 520 is an indicator of the incoming frames 512 of a stream that have been returned by the stream organizer 520 to a stream reader 518 thus far. In general, a stream organizer 520 is configured to return an incoming frame 512 to a stream reader 518 when the frame offset of that incoming frame 512 matches the flow offset maintained by the stream organizer 520. When a stream organizer 520 receives an incoming frame 512 that indicates a frame offset that is greater than a current flow offset, the stream organizer 520 may add that incoming frame 512 to an ordered queue of frames 512 maintained by the stream organizer 520. When a stream organizer 520 transmits an incoming frame 512 back to a stream reader 518, the stream organizer 520 is configured to increment a flow offset commensurate to a frame length indicated by that incoming frame 512.

In an embodiment, a stream organizer 520 is a runtime object that is related to an ordered flow reference type. As an example, assume that the ordered flow reference type is an ordered flow class, and further assume that incoming frames 512 are QUIC frames. The QUIC frames of this example may include crypto frames, stream frames, and other types of QUIC frames. In this example, the ordered flow class implements a QUIC frame class, and the stream organizer 520 is an instance of a subclass that extends the ordered flow class. For instance, the stream organizer 520 of this example may be an instance of a crypto data flow class that extends the ordered flow class, an instance of a stream data flow class that extends the ordered flow class, or an instance of another subclass that extends the ordered flow class. In this embodiment, a flow offset for a stream is stored to an object field of a stream organizer 520, and an ordered queue of frames maintained by the stream organizer 520 may be a separate runtime object that is manipulated by the stream organizer 520. For example, an ordered queue of frames may be manifested as an instance of a concurrent skip list set class.

In an embodiment, a read loop 522 is a mechanism for processing outgoing stream data. A read loop 522 is configured to process outgoing stream data by manipulating outgoing frames 516, buffers 514, and/or other information. A read loop 522 is configured for processing outgoing frames 516 associated with a particular protocol, or the read loop 522 is configured for parsing outgoing 516 frames associated with multiple protocols. A read loop 522 is configured for processing the outgoing frames 516 of a single stream, or the read loop 522 is configured for processing the outgoing frames 516 of multiple streams.

In an embodiment, a read loop 522 is a runtime object that is related to a read loop reference type. As an example, assume that outgoing frames 516 are manifestations of HTTP/3 frames. In this example, the read loop is an instance of an HTTP/3 exchange implementation class, and the HTTP/3 implementation class extends an HTTP/3 stream class.

In an embodiment, a read loop 522 provides method(s) for processing stream data. An example method offered by a read loop 522 for processing stream data is configured to (a) facilitate the processing of stream data by other components of system 500 and (b) deliver the processed stream data to stream recipient(s). For instance, the example method for processing stream data may be configured to (a) poll buffers 514 from a queue of buffers 514 maintained by a stream reader 518, (b) submit the polled buffers 514 to a frames decoder 524 for decoding, (c) poll the frames decoder 524 for outgoing frames 516 decoded by the frames decoder 524, (d) query the frames decoder 524 for payload data of a decoded partial frame, (e) deliver decoded data of outgoing frames 516 to stream recipient(s), and/or (f) perform other operations. Data of an outgoing frame 516 that may be delivered to a stream recipient by the example method for processing stream data may include (a) payload data of the outgoing frame 516, (b) frame metadata of the outgoing frame 516, (c) and/or other information (e.g., an error code associated with a malformed frame). The example method for processing stream data may be configured to identify an appropriate stream recipient for decoded data of an outgoing frame 516 based on (a) the frame type of the outgoing frame 516, (b) how the outgoing frame 516 is modeled (e.g., partial frame, complete frame, malformed frame, etc.), (c) the content of the outgoing frame 516, and (d) other information.

In an embodiment, a read loop 522 offers a method for processing stream data, and the method for processing stream data is configured to deliver stream data to stream recipient(s). In an example, incoming frames 512 are QUIC frames that embed HTTP/3 frames (i.e., outgoing frames 516). In this example, a read loop 522 offers a “process QUIC data” method, and the process QUIC data method is configured to deliver stream data to one or more stream recipients. Stream recipient(s) of this example may include an HTTP response subscriber, a connection handler, a stream manager, a connection-level push handler, and others. Typically, if an outgoing frame 516 is an HTTP/3 data frame, the process QUIC data method of this example will attempt to deliver payload data of the HTTP/3 data frame to one or more HTTP response subscribers. Example HTTP response subscribers include web browsers, API clients, media players, server-sent events clients, web sockets, file downloaders, machine learning pipelines, and others. The process QUIC data method of this example is configured to deliver payload data of an HTTP/3 data frame to an HTTP response subscriber by (a) adding that payload data to a queue of stream data and (b) pushing the data in the queue of stream data to the HTTP response subscriber. In this example, the queue of stream data is manifested in managed memory area 510 as an instance of a concurrent linked queue class, and payload data of an HTTP/3 data frame is manifested in managed memory area 510 as a list of byte buffers (e.g., an instance of a class that implements a list interface). In this example, the concurrent linked queue instance offers an “add” method, and the process method of the read loop 522 is configured to add the stream data to the queue of stream data by invoking the add method on the concurrent linked queue instance while specifying a list of byte buffers as an input parameter. Furthermore, in this example, read loop 522 offers a “push response data” method that is configured to push data in the queue of stream data to an HTTP response subscriber if that HTTP response subscriber is ready to consume that data. After adding the stream data to the queue of stream data in this example, the process QUIC data method is configured to invoke the push response data method of the read loop 522.

In an embodiment, a frames decoder 524 is a mechanism for decoding stream data. In particular, a frames decoder 524 is a mechanism for decoding stream data delivered to the system in incoming frames 512. For instance, a frames decoder 524 may extract outgoing frames 516 from the payloads of incoming frames 512. To this end, a frames decoder 524 is configured to manipulate buffers 514, a buffers reader 526, and/or other information. A frames decoder 524 is configured for extracting outgoing frames 516 associated with a particular protocol, or the frames decoder 524 is configured for extracting outgoing frames 516 associated with multiple protocols. A frames decoder 524 is configured for extracting outgoing frames 516 of a single stream, or the frames decoder 524 is configured for extracting outgoing frames 516 of multiple streams. In an example, a frames decoder 524 is configured to accept buffers 514 from read loop 522, submit the buffers 514 to a buffers reader 526, decode stream data aggregated by the buffers reader 526 to generate outgoing frames 516, and transmit the outgoing frames 516 to the read loop 522.

In an embodiment, a frames decoder 524 provides methods for manipulating buffers 514, outgoing frames 516, and/or other information. For example, a frames decoder 524 may provide a method for submitting buffers 514 to the frames decoder 524, a method for polling outgoing frames 516 from the frames decoder 524, a method for retrieving data from a buffers reader 526, and other methods. An example poll method called on a frames decoder 524 returns a complete frame, a partial frame, an unknown frame, a malformed frame, or another variety of outgoing frame 516. The example poll method may call a static decode method of an outgoing frame reference type (e.g., an outgoing frames interface).

In an embodiment, a frames decoder 524 is a runtime object that is related to a frames decoder reference type. In an example, a frames decoder 524 is an instance of a frames decoder class. The frames decoder 524 of this example may be created by calling a static method of the frames decoder class.

In an embodiment, a frames decoder 524 maintains variable(s) for tracking the decoding of a stream. An example frames decoder 524 maintains a partial frame instance variable. The partial frame instance variable of the example frames decoder 524 indicates if there is an outgoing frame 516 modeled as a partial frame that is currently being decoded. Typically, the partial frame instance variable is either (a) set to reference an outgoing frame 516 modeled as a partial frame or (b) set to null. If the partial frame instance variable refers to an outgoing frame 516 in this example, that outgoing frame 516 is the partial frame that is currently being decoded. Alternatively, if the partial frame instance variable is set to null in this example, there is no partial frame that is currently being decoded. An outgoing frame 516 that is referenced by a partial frame instance variable of a frames decoder 524 is referred to herein as a “current partial frame.”

In an embodiment, a frames decoder 526 offers method(s) for retrieving elements that encode the payload of an outgoing frame 516. An example frames decoder 526 offers a “read payload bytes” method that can be used to retrieve undelivered payload data of an outgoing frame 516 modeled as a partial frame. If the payload of an outgoing frame 516 that is the current partial frame has not been fully decoded when the read payload bytes method is invoked, the read payload bytes method is configured to return the undelivered bytes encoding the payload that are presently available for decoding. The read payload bytes method is configured to return these bytes as a list of byte buffer(s).

In an embodiment, a buffers reader 526 is a mechanism configured to act as an abstraction of one or more buffers 514. While serving as an abstraction of buffer(s) 514, a buffers reader 526 presents the elements represented by those buffer(s) 514 as a continuous sequence of element(s) that can be accessed and manipulated through the buffers reader 526. A buffers reader 526 is configured to serve as an abstraction of a particular variety of buffers 514 (e.g., a byte buffers 514), or a buffers reader 526 is configured to serve as an abstraction of multiple varieties of buffers 514. A buffers reader 526 is a single buffers reader 526, or the buffers reader 526 is a list buffers reader 526. As the name suggests, a single buffers reader 526 is configured to act as an abstraction of a single buffer 514. A list buffers reader 526 is configured to act as an abstraction of one or more buffers 514. A list buffers reader 526 maintains a list of abstracted buffers 514, and the list buffers reader 526 acts as an abstraction of any buffers 514 that are entered into the list.

In an embodiment, a buffers reader 526 is a runtime object that is related to a buffers reader reference type. A buffers reader reference type and/or subclasses of the buffers reader reference type define methods (e.g., factory methods, constructors, etc.) that can be invoked to create a buffers reader 526. In an example, the buffers reader reference type is an abstract buffers reader class, and a buffers reader 526 is an instance of a subclass that extends the abstract buffers reader class. In particular, the buffers reader 526 of this example is an instance of a single buffers reader subclass that extends the buffers reader class, or the buffers reader 526 is an instance of a list buffers reader subclass that extends the buffers reader class.

In an embodiment, a buffers reader 526 acting as an abstraction of buffer(s) 514 presents elements represented by those buffer(s) 514 as a continuous sequence of element(s) that are consecutively indexed. An example continuous sequence of elements is indexed by a buffers reader 526 starting from zero. The index assigned to an element by a buffers reader 526 is referred to herein as the “global position” of that element. It should be noted that the indexing of an element by a buffers reader 526 may differ from how that same element is indexed by (a) a buffer 514 that represents that element and/or (b) an underlying data structure that stores that element. In other words, the global position of an element may differ from (a) the relative position of that element and/or (b) the local position of that element. A differential between the global position of an element and the relative position of the element is referred to herein as an “index differential.” For example, a differential between an index value assigned to an element by a buffers reader 526 and an index value assigned to that same element by a buffer 514 that is aggregated by the buffers reader 526 may be identified herein as the “index differential” of that buffer 514.

In an embodiment, a buffers reader 526 is a list buffers reader 526, and the buffers reader 526 maintains a list of abstracted buffers 514. An entry in a list of abstracted buffers 514 may record attributes of the buffer 514 corresponding to that entry. An example list of abstracted buffer 514 is indexed starting from zero where list index zero corresponds to the leading entry in the example list of abstracted buffers 514. It should be noted that the indexing of entries in a list of abstracted buffers 514 is separate from the indexing of elements in a continuous sequence of elements. An example entry in a list of abstracted buffers 514 is an instance of a record class, and the example entry includes (a) a reference to a buffer 514 that corresponds to the example entry, (b) an initial read position of that buffer 514, (c) a limit of that buffer 514, and/or (d) other information. Generally, the initial read position of a buffer 514 entered in a list of abstracted buffers 514 is the read position of that buffer 514 at the time that buffer 514 is entered into the list; however, this may not always be the case. For example, the leading entry in a list of abstracted buffers 514 may record the initial read position of the corresponding buffer 514 as zero even if the true read position of that buffer 514 is not zero at the time the buffer 514 is entered into the list. It should be noted that whether or not a buffer 514 entered into a list of abstracted buffers 514 possesses an index differential greater than zero may depend on where that buffer 514 is entered within the list. A preceding buffer 514 in a list of abstracted buffers 514 will typically contribute to the index differential of a latter buffer 514 in the list. As used herein, the “relative offset” of a buffer 514 included in a list of abstracted buffers 514 refers to an increase in the index differential of that buffer 514 that results from any other buffers 514 that precede that buffer 514 in the list. A relative offset is not the sole factor that may contribute to the index differential of a buffer 514 entered in a list of abstracted buffers 514. For instance, the initial read position of a buffer 514 when that buffer 514 is entered into a list of abstracted buffers 514 may also impact an index differential of that buffer 514. As an example, consider a buffer 514 that is entered into a list of abstracted buffers 514, and assume that there are other buffers 514 that precede the newly added buffer 514 in the list. If the buffer 514 is partially read when the buffer 514 is entered into the list of abstracted buffers 514 in this example, the buffers reader 526 may exclude the read elements of that buffer 514 from a continuous sequence of elements that is presented by the buffers reader 526. Elements excluded from the continuous sequence of elements by the buffers reader 526 in this example are not indexed by the buffers reader 526. As a result, the index differential of that buffer 514 may be altered by an amount corresponding to the read position of the buffer 514 when that buffer 514 is entered into the list of abstracted buffers 514 in this example (i.e., the initial read position of that buffer 514).

In an embodiment, a buffers reader 526 maintains variable(s) that track characteristics of (a) the buffers reader 526, (b) any buffers 514 abstracted by the buffers reader 526, and/or (c) elements included in a continuous sequence of elements presented by the buffers reader 526. Example variables that may be maintained by a buffers reader 526 include (a) a start position, (b) a read position, (c) a limit, (d) a current pointer, (e) a current offset, (f) a next index, (g) a read and released counter, (h) a capacity, and (i) others. The start position of a buffers reader 526 is the global position of the first element in a continuous sequence of elements that is accessible through the buffers reader 526. A buffers reader 526 may deny a request that attempts to retrieve an element residing before the buffers reader's 526 start position. The read position of a buffers reader 526 indicates the global position of an element in a continuous sequence of elements presented by the buffers reader 526. In particular, the read position of a buffers reader 526 indicates the global position of the element that should be read next. The limit of a buffers reader 526 is the global position of the first element that is inaccessible through the buffers reader 526. For example, if the limit of a buffers reader 526 is twenty, the last element that should be accessible through the buffers reader 526 resides at global position nineteen. The current pointer of a buffers reader 526 may hold a reference to a buffer 514 in a list of abstracted buffers 514 maintained by the buffers reader 526. A buffer 514 that is referenced by the current pointer of a buffers reader 526 is referred to herein as a “current buffer” 514. If a current pointer of a buffers reader 526 is not set to null, the current pointer will typically reference the buffer 514 that represents the element residing at the read position of the buffers reader 526. In other words, the current buffer 514 of a buffers reader 526 is typically the buffer 514 that is currently being read through the buffers reader 526. The current offset of a buffers reader 526 is the relative offset of the buffers reader's 526 current buffer 514. The current offset of a buffers reader 526 may change whenever the current buffer 514 of the buffers reader 526 changes. If the current pointer of a buffers reader 526 is not set to null (i.e., there is a current buffer 514), the next index of the buffers reader 526 indicates the entry in a list of abstracted buffers 514 that immediately follows the current buffer's 514 entry in the list. The read and released counter of a buffers reader 526 measures the number of elements that have been read through the buffers reader 526 and released from the continuous sequence of elements presented by the buffers reader 526. The capacity of the buffers reader 526 is the number of elements presently included in a continuous sequence of elements presented by the buffers reader 526. In an example, variable(s) of a buffers reader 526 are larger than comparable variable(s) that are maintained by a buffer 514. For instance, the read position and limit of an example buffers reader 526 may be longs, whereas the read position and limit of an example buffer 514 may be integers.

In an embodiment, a buffers reader 526 offers method(s) for retrieving and/or altering variables that are maintained by the buffers reader 526. For example, a buffers reader 526 may offer methods that return or alter (a) a start position of the buffers reader 526, (b) a read position of the buffers reader 526, (c) a limit of the buffers reader 526, (d) a current offset of the buffers reader 526, (e) a current pointer of the buffers reader 526, (f) a next index of the buffers reader 526, (g) a read and released counter, and/or (h) other information. In general, a method that alters a variable of a buffers reader 526 may also alter a method of a buffer 514 that is abstracted by the buffers reader 526. For example, a change to the read position of a buffers reader 526 may be accompanied by a corresponding change to the read position of buffer(s) 514 that are abstracted by the buffers reader 526. A method of a buffers reader 526 may alter a variable of a buffer 514 by invoking a method offered by the buffer 514.

In an embodiment, a buffers reader 526 offers methods for adding a buffer 514 to the buffers reader 526. Once a buffer 514 is added to a buffers reader 526, that buffers reader 526 acts as an abstraction of that buffer 514. An example buffers reader 526 offers an “add” method that is configured to (a) accept a buffer 514 as an input parameter and (b) enter that buffer 514 into a list of abstracted buffers 514 maintained by the buffers reader 526. The example buffers reader 526 also offers an “add all” method that is configured to (a) accept a list of buffers 514 as an input parameter and (b) enter the buffers 514 in the list of buffers 514 into a list of abstracted buffers 514 maintained by the buffers reader 526.

In an embodiment, a buffers reader 526 offers method(s) for reading element(s). As used herein, the phrase “reading through a buffers reader” 526 refers to retrieving elements(s) that are included in a continuous sequence of elements presented by the buffers reader 526 and recording those element(s) as being read. An example buffers reader 526 offers a relative “get” method that is configured for reading through the buffers reader 526. If invoked, the relative get method is configured to (a) return the element residing at the read position of the example buffers reader 526 and (b) increment the read position of the example buffers reader 526 by one element. For instance, if the example buffers reader 526 aggregates byte buffers 514, the relative get method is configured to (a) return the byte residing at the read position of the example buffers reader 526 and (b) increment the read position of the example buffers reader 526 by one byte.

In an embodiment, a buffers reader 526 offers method(s) for pecking elements. As used herein, the phrase “pecking through a buffers reader” 526 refers to retrieving element(s) from a continuous sequence of elements presented by the buffers reader 526 without marking those element(s) as read. An example buffers reader 526 offers an absolute “get” method that can be used to peek an element residing at a global position that is specified as an input parameter. The absolute get method does not alter the read position of the example buffers reader 526. Recall that a buffers reader 526 may offer a method for altering the read position of the buffers reader 526. If appropriate, a component of the system can mark an element as read after pecking that element through a buffers reader 526 by altering the buffers reader's 526 read position.

In an embodiment, a buffers reader 526 offers method(s) for releasing elements from a continuous sequence of elements presented by the buffers reader 526. An example buffers reader 526 provides a “release” method that is configured to (a) release any read elements from a continuous sequence of elements, (b) reset the read position of the example buffers reader 526 to zero, and (c) set the limit of the example buffers reader 526 to the remaining number of elements in the continuous sequence of elements. The example buffers reader 526 also offers a “clear” method that is configured to release all elements included in the continuous sequence of elements presented by the example buffers reader 526.

In an embodiment, a buffers reader 526 offers method(s) for (a) reading element(s) included in a continuous sequence of elements presented by the buffers reader 526 and (b) releasing the element(s) that are read. An example buffers reader 526 offers a “get and release” method. The get and release method accepts a number of elements as an input parameter, and the get and release method is configured to (a) return that number elements starting with the element residing at the read position of the example buffers reader 526, (b) release those elements that are returned, (c) set the read position of the buffers reader 526 to zero, and (d) update the limit of the buffers reader 526 to reflect the remaining number of elements included in a continuous sequence of elements presented by the example buffers reader 526.

In an embodiment, a buffers reader 526 offers method(s) for determining the status of information presented by the buffers reader 526. For instance, among other methods, an example buffers reader 526 offers a “has remaining” method, a “remaining” method, and an “is empty” method. The has remaining method is a Boolean method that returns true if a sequence of elements presented by the example buffers reader 526 includes at least one unread element. The remaining method of the example buffers reader 526 is an integer method that returns the number of unread elements included within a continuous sequence of elements presented by the example buffers reader 526. The is empty method of the example buffers reader 526 is a Boolean method that returns true if the buffers reader 526 is not presently acting as an abstraction for any buffer 514.

In an embodiment, a buffers reader 526 offers method(s) for writing to element(s) included in a continuous sequence of elements presented by the buffers reader 526. An example buffers reader 526 provides a relative “put” method. The relative put method accepts an element as an input parameter, and the relative put method is configured to (a) write the element at the read position of the example buffers reader 526 and (b) increment the read position of the example buffers reader 526. The example buffers reader 526 also offers an absolute “put” method. The absolute put method of the example buffers reader 526 accepts a global position and an element as input parameters, and the absolute put method is configured to write the element to the global position.

In an embodiment, a buffers reader 526 offers a getter method for retrieving the read position of the buffers reader 526, and the buffers reader 526 offers a setter method for moving the read position of the buffers reader 526. An example buffers reader 526 offers a “position” method that is configured to return the read position of the example buffers reader 526, and the example buffers reader 526 offers another “position” method that is configured to move the read position of example buffers reader 526 to a relative position that is specified as an input parameter.

In an embodiment, a buffers reader 526 offers a getter method for retrieving the limit of the buffers reader 526, and the buffers reader offers a setter method for altering the limit of the buffers reader 526. An example buffers reader 526 offers a “limit” method that returns the limit of the example buffers reader 526, and the example buffers reader 526 offers another “limit” method that is configured to move the limit of the example buffers reader 526 to a relative position that is specified as an input parameter.

In an embodiment, system 500 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

### 4. PARSING STREAM DATA

FIG. 6 illustrates an example set of operations for parsing stream data in accordance with one or more embodiments. One or more operations illustrated in FIG. 6 may be modified, rearranged, or omitted. Accordingly, the particular sequence of operations illustrated in FIG. 6 should not be construed as limiting the scope of one or more embodiments.

In an embodiment, a stream reader obtains incoming frames, and the stream reader transmits the incoming frames to a stream organizer (Operation 602). The incoming frames embed outgoing frames. More specifically, at least some of the incoming frames are frames that carry higher-level protocol binary payloads, and at least some of these payloads encode outgoing frames. The payload of an incoming frame may encode a portion of an outgoing frame, an entire outgoing frame, and/or multiple outgoing frames. If an incoming frame carries a payload, the payload may be stored to a buffer of the system. The incoming frames also include frame metadata (e.g., frame types, stream IDs, frame offsets, frame lengths, etc.) that the system uses to parse the incoming frames. The incoming frames are delivered to the system through a network connection. Stream data transported through a network connection may get lost, may be partially retransmitted, and/or may be duplicated. Accordingly, the stream reader may obtain the incoming frames in an incorrect order, and the incoming frames obtained by the stream reader may include overlapping frames and duplicate frames. The stream reader transmits the incoming frames to the stream organizer in a sequence and condition that is congruent to the sequence and condition that the incoming frames are obtained by the stream reader. Accordingly, the incoming frames may be transmitted to the frames organizer out of order, and the incoming frames transmitted to the stream organizer may include overlapping frames and duplicate frames. The stream reader relies on the stream organizer to transmit the incoming frames back to the stream reader in an ordered flow of incoming frames that includes neither duplicate frames nor overlapping frames. In an example, the stream reader provides a process incoming frame method, and the stream organizer provides a receive method. In this example, the stream reader obtains an incoming frame as a result of a remote peer calling the process incoming frame method on the stream reader while specifying the incoming frame as an input parameter. While performing the process incoming frame method in this example, the stream reader, in turn, transmits the incoming frame to the stream organizer by calling the receive method on the stream organizer while specifying the incoming frame as an input parameter. Typically, in this example, the receive method of the stream organizer will return an incoming frame that is ready for further processing, or the receive method will return null. If the receive method returns an incoming frame in this example, that incoming frame is the same incoming frame that was specified as an input parameter while invoking the receive method, or that incoming frame is a different incoming frame. In addition to the receive method, the stream reader of this example can request incoming frames from the stream organizer by calling a poll method that is provided by the stream organizer.

Recall that a protocol (e.g., the QUIC Protocol) may permit multiple streams to be established over a single network connection. Accordingly, in an embodiment, any given incoming frame that is received by the system could belong to any one of multiple streams that are established over a single network connection. If multiple streams are established over a network connection, the system may rely on multiple stream readers, stream organizers, read loops, frames decoders, and buffers readers for parsing the multiple streams. In an example, at least one dedicated stream reader, stream organizer, read loop, frames decoder, and buffers reader is created for each stream. However, in other examples, component(s) of the system are configured to parse stream data associated with multiple streams. For instance, in another example, a stream reader is configured to receive incoming frames belonging to multiple streams. The system is configured to dispatch any given incoming frame to the appropriate stream reader based on a stream ID and/or other frame metadata that is included in the incoming frame. If no presently existing stream reader is responsible for parsing the incoming frames associated with a stream, the system may create a new stream reader for that stream, and the system may create other components (e.g., a stream organizer, a read loop, a frames decoder, a buffers reader, etc.) for that stream as needed.

Multiple protocols may influence how the incoming frames are transmitted to the system. For instance, in an embodiment, the incoming frames are associated with at least one lower-layer protocol (e.g., a transport-layer protocol), and the outgoing frames are associated with at least one higher-layer protocol (e.g., an application-layer protocol). Depending on the protocols in play, the outgoing frames may have been arbitrarily split and segmented before being encoded into the payloads of the incoming frames that are delivered to the system through the network connection. The lower-layer frames are delivered to the system packaged within lower-layer packets. A lower-layer packet may include a portion of a lower-layer frame, the entirety of a lower-layer frame, and/or multiple lower-layer frames. If a lower-layer packet includes multiple lower-layer frames (i.e., in whole or in part), the multiple lower-layer frames may belong to the same stream, or the multiple lower-layer frames may belong to different streams. The payloads of the lower-layer frames include the higher-layer frames. A payload of a lower-layer frame may include a portion of a higher-layer frame, the entirety of a higher-layer frame, and/or multiple higher-layer frames.

In an embodiment, the stream organizer organizes the incoming frames, and the stream organizer transmits the incoming frames back to the stream reader in an ordered flow (Operation 604). The stream organizer organizes the incoming frames by reordering incoming frames, replacing incoming frames, discarding incoming frames, and/or performing other operations. To organize the incoming frames of a stream, the stream organizer maintains a flow offset for that stream, and the stream organizer maintains an ordered queue of frames that cannot yet be transmitted back to the stream reader. The flow offset indicates a specific position (e.g., an address of a byte) within the stream; any stream data preceding the flow offset is included within the payloads of incoming frames that have already been transmitted by the stream organizer back to the stream reader (i.e., released for further processing). Based on the flow offset and frame metadata held by the incoming frames (e.g., frame offsets and frame lengths), the stream organizer identifies unordered incoming frames, overlapping incoming frames, and/or duplicate incoming frames. Recall that the frame offset of an incoming frame indicates the starting position of the incoming frame's payload in a stream, and the frame length of the incoming frame indicates the size of the payload. In general, the stream organizer transmits an incoming frame back to the stream reader if the frame offset of that incoming frame matches the flow offset for that stream. When the stream organizer transmits an incoming frame back to the stream reader, the stream organizer advances the flow offset commensurate to the frame length indicated by that incoming frame. In an example, the stream organizer returns an incoming frame to the stream reader responsive to the stream reader calling a receive method on the stream organizer, and/or the stream organizer returns an incoming frame to the stream reader responsive to the stream reader calling a poll method on the stream organizer.

In an embodiment, the stream organizer adds an incoming frame to an ordered queue of frames maintained by the stream organizer if the incoming frame cannot yet be transmitted back to the stream reader. In particular, an incoming frame is added to an ordered queue if (a) the frame offset of the incoming frame is greater than the flow offset of the corresponding stream, (b) the incoming frame is not a duplicate of another incoming frame that is already in the ordered queue, and (c) the incoming frame does not overlap with another incoming frame that is already in the ordered queue. In an example, the stream organizer organizes the ordered queue according to the frame offsets held by the incoming frames that are constituents of the ordered queue. In this example, an incoming frame with an inferior frame offset appears in the ordered queue before another incoming frame with a greater frame offset. When the stream organizer advances the flow offset, the stream organizer may also check if the advancement of the flow offset has rendered a leading frame in the ordered queue (i.e., an incoming frame listed at the front of the ordered queue) eligible for transmission back to the stream reader. In particular, the stream organizer may check if a newly-advanced flow offset matches the frame offset of the leading frame in the ordered queue.

In an embodiment, if an incoming frame delivers a payload that is partially extraneous, the stream organizer replaces the incoming frame with a new frame having a new payload. The new payload of the new frame (a) includes relevant data delivered by the incoming frame and (b) excludes the extraneous data delivered by the incoming frame. To make better use of the system's available resources, the stream organizer selects an approach for creating the new frame based on the circumstances. For instance, the stream organizer may choose to create the new frame by slicing the incoming frame, to minimize the computational cost of creating the new frame. Alternatively, the stream organizer may choose to create the new frame by partitioning the incoming frame, to reduce the amount of memory space that is occupied by the new frame while the system is processing the new frame. If the stream organizer creates the new frame by slicing the incoming frame, the amount of memory space that is occupied by the new frame includes both (a) the memory space allocated for storing the relevant information delivered by the incoming frame and (b) the memory space allocated for storing the extraneous information delivered by the incoming frame. Accordingly, if the incoming frame is sliced, the system is delayed from reclaiming the memory space allocated for the extraneous information until after the new frame is fully processed. In comparison, if the stream organizer creates the new frame by partitioning the incoming frame, the amount of memory space occupied by the new frame does not include the memory space allocated for the extraneous information. Accordingly, if the incoming frame is partitioned, the system is typically allowed to reclaim the memory space allocated for the extraneous information shortly after the new frame is created.

In an embodiment, the stream organizer eliminates an overlap between incoming frames by generating a new frame to replace an incoming frame that overlaps with another incoming frame. As an example, consider an incoming frame that overlaps with another incoming frame. In particular, the payload of the incoming frame overlaps with the payload of the other incoming frame in this example. For the purposes of this example, assume that the other incoming frame has already been transmitted back to the stream reader or is currently residing in the ordered queue. Accordingly, the stream organizer generates a new frame to replace the incoming frame in this example. The stream organizer of this example determines a frame offset, a frame length, and other attributes of the new frame. The frame offset and frame length of the new frame reflect the position and size of the non-overlapping portion of the incoming frame's payload in this example. The frame offset of the new frame is the same as the frame offset of the incoming frame (e.g., if a trailing portion of the original payload overlaps with the other payload), or the frame offset of the new frame is different than the frame offset of the incoming frame (e.g., if a leading portion of the original payload overlaps with the other payload). Furthermore, the stream organizer of this example invokes a method on the buffer that represents the payload of the incoming frame (e.g., a slice method, an allocate method, etc.), and the other method provides instructions for creating a new buffer to represent the non-overlapping portion of the incoming frame's payload. After generating the new frame and the new buffer, the new frame is either promptly returned to the stream organizer or added to the ordered queue depending on the frame offset of the new frame relative to the current flow offset. The original incoming frame is subsequently discarded.

In an embodiment, the stream reader receives the incoming frames transmitted from the stream organizer, and the stream reader presents the payloads of the incoming frames to a read loop in a queue of buffers (Operation 606). The buffers in the queue of buffers store the payloads of the incoming frames. The stream reader adds a buffer to the queue of buffers when a corresponding incoming frame is transmitted back to the stream reader by the stream organizer. Buffers are presented within the queue of buffers according to the sequence that the corresponding incoming frames are transmitted back to the stream reader by the stream organizer. Recall that the stream organizer transmits the incoming frames back to the stream reader in an ordered flow. Therefore, the order of the buffers in the queue of buffers accords to the correct sequence that the payloads stored to the buffers are intended for delivery within the stream. In an example, the payloads of the incoming frames carry binary stream data, and the buffers storing the payloads are byte buffers. In this example, the stream reader is effectively translating the ordered flow of frames returned by the stream organizer into an ordered flow of bytes that is presented by the queue of byte buffers. If the queue of buffers accumulates a sufficient number of buffers for consumption by the read loop, the stream reader may trigger the consumption of the buffers by the read loop. In an example, the stream reader triggers the read loop by invoking a read loop method on the read loop. If the queue of buffers includes an insufficient number of buffers for consumption by the read loop, the stream reader may continue to transmit incoming frames to the stream organizer, and/or the stream reader may poll the stream organizer for additional incoming frames.

In an embodiment, the read loop retrieves the buffers that are presented in the queue of buffers maintained by the stream reader, and the read loop transmits the buffers to a frames decoder (Operation 608). Recall that the buffers store payloads of incoming frames, and the payloads of the incoming frames encode outgoing frames. The read loop relies on the frames decoder to decode the stream data that is carried by these payloads. In other words, the read loop is relying on the frames decoder to extract the outgoing frames from the payloads of the incoming frames represented by the buffers. The read loop transmits the buffers to the frames decoder in the sequence that the buffers are presented in the queue of buffers. Further recall that the queue of buffers is ordered in a correct sequence that the payloads stored to the buffers are intended for delivery within the stream. In an example, the read loop provides a read loop method, and the read loop method is called on the read loop (e.g., the runtime object that is the read loop). In response, the read loop of this example begins to consume the buffers presented in the queue of buffers maintained by the stream reader. In this example, while the read loop method is executing, the read loop obtains a buffer from the queue of buffers as a result of the read loop invoking a poll method on the stream reader. Upon obtaining a buffer from the queue of buffers in this example, the read loop passes the buffer to the frames decoder by calling a submit method on the frames decoder while specifying the buffer as a parameter of the request.

In an embodiment, the frames decoder receives buffers transmitted from the read loop, and the frames decoder adds the buffers to a buffers reader (Operation 610). The buffers reader is a list buffers reader that is capable of wrapping multiple buffers. Recall that, depending on the protocols that governed the transmission of the incoming frames to the system, the outgoing frames may have been indiscriminately split and segmented before being encoded into the incoming frames. While the frames decoder will receive the buffers in an order that corresponds to the correct sequence of stream data within the stream, generating an outgoing frame by way of interacting with individual buffers may nonetheless be a non-trivial task to the extent that the outgoing frame is arbitrarily divided amongst multiple buffers. To avoid the computational complexity that would be incurred while attempting to reconstruct an outgoing frame that has been dispersed across multiple buffers, the frames decoder relies on the buffers reader to serve as an abstraction of the multiple buffers. The buffers reader maintains a list of abstracted buffers, and the buffers reader presents a continuous sequence of elements. If a buffer is entered into the list of abstracted elements, elements represented by that buffer may be included in the continuous sequence of elements that is presented by the buffers reader. In an example, the buffers reader provides an add method, and the frames decoder transmits a buffer to the buffers reader by calling the add method on the buffers reader while specifying the buffer as a parameter of the request.

In an embodiment, the frames decoder extracts outgoing frames from the payloads of the incoming frames that are aggregated by the buffers reader, and the frames decoder transmits the outgoing frames to the read loop (Operation 612). In an example, the frames decoder decodes stream data encoded into the continuous sequence of elements presented by the buffers reader by calling a decode method of an outgoing frame reference type while specifying the buffers reader as a parameter of the request. In this example, the decode method is a static method of an outgoing frame reference type. By presenting the elements represented by the individual buffers as a continuous sequence of elements, the buffers reader allows the decode method of this example to read stream data that is split across multiple buffers as if the stream data were instead represented by a single buffer. Typically, in this example, the decode method returns an outgoing frame that is decoded from the continuous sequence of elements, or the static decode method returns null. If the static decode method returns an outgoing frame in this example, the outgoing frame is (a) a complete frame, (b) a partial frame, (c) an unknown partial frame, (d) a malformed frame, or (c) another variety of an outgoing frame.

In an embodiment, the read loop delivers the outgoing frames to a stream recipient (Operation 614). An outgoing frame delivered to the stream recipient is a complete frame, a partial frame, a malformed frame, or another variety of outgoing frame. Returning a partial frame to the stream recipient rather than a complete frame may allow the read loop to begin delivery of the partial frame's payload to the stream recipient prior to the entirety of the partial frame being decoded. The ability to begin delivery of a frame's payload prior to the entirety of that payload being decoded may reduce the amount of buffer memory that is consumed by the system and reduce the overall latency of stream data delivery. An outgoing frame may be delivered to a stream recipient as a runtime object related to an outgoing frame reference type, as stream data formatted according to a protocol associated with that outgoing frame, and/or in any another medium.

### 5. DELIVERING STREAM DATA

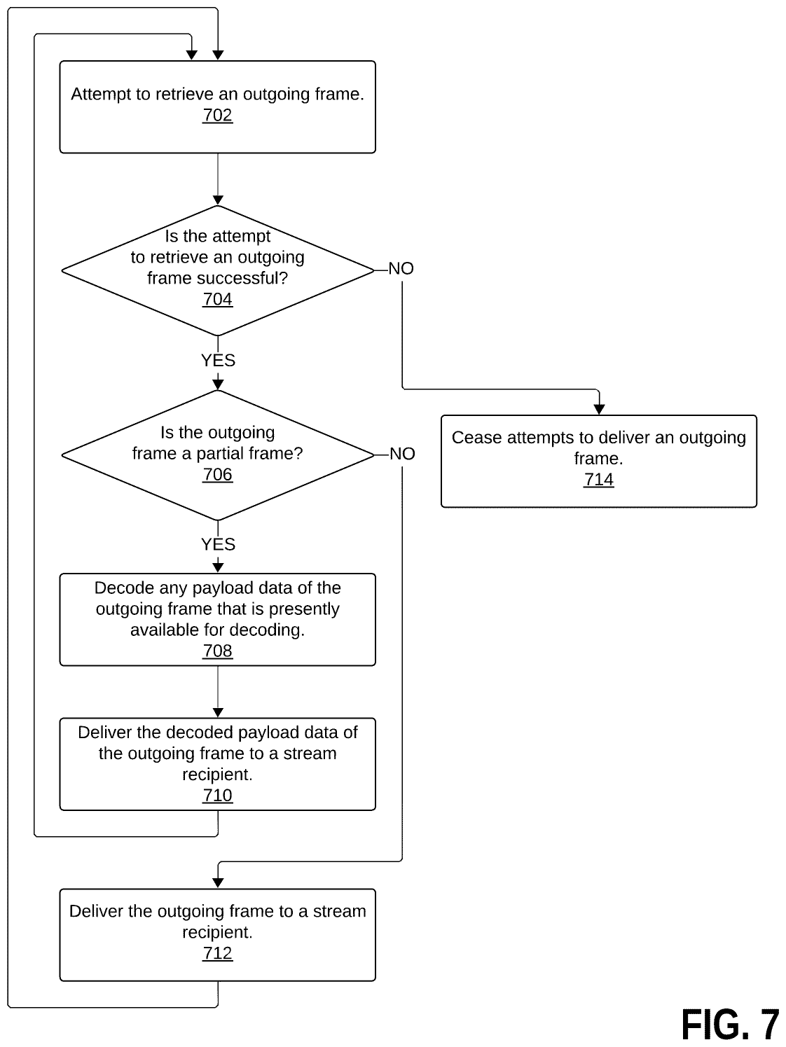

FIG. 7 illustrates an example set of operations for delivering stream data in accordance with one or more embodiments. One or more operations illustrated in FIG. 7 may be modified, rearranged, or omitted. Accordingly, the particular sequence of operations illustrated in FIG. 7 should not be construed as limiting in accordance with one or more embodiments. In an embodiment, the operations illustrated by FIG. 7 are performed by the system while the system is executing a method of a read loop that is configured for processing units of stream data (hereafter the “process method”); to provide consistent examples, the examples described in this Section 5 assume the same.

In an embodiment, the system attempts to retrieve an outgoing frame (Operation 702). Example operations for retrieving an outgoing frame are described below in Section 6 titled “Retrieving an Outgoing Frame.” In an example, the system attempts to retrieve an outgoing frame from a frames decoder by executing a poll method that is offered by the frames decoder. In this example, the process method of the read loop invokes the poll method on the frames decoder.

In an embodiment, the system determines if the attempt to retrieve an outgoing frame is successful, and the system proceeds to another operation based on the determination (Operation 704). If the attempt to retrieve an outgoing frame is successful (YES at Operation 704), the system proceeds to Operation 706. Alternatively, if the attempt to retrieve an outgoing frame is not successful (NO at Operation 704), the system proceeds to Operation 714. In an example, the system concludes that the attempt to retrieve an outgoing frame is successful because a poll method executed on a frames decoder returns a complete frame, a partial frame, a malformed frame, or another variety of outgoing frame. In an alternative example, the system concludes that the attempt to retrieve an outgoing frame is unsuccessful because a poll method executed on a frames decoder returns null or throws an exception. If the poll method of the frames decoder returns null in this alternative example, the process method of the read loop may transition to polling a stream reader for additional buffers that can be added to a buffers reader.

In an embodiment, the system determines if the newly retrieved outgoing frame is a partial frame, and the system proceeds to another operation based on the determination (Operation 706). If the outgoing frame is a partial frame (YES at Operation 706), the system proceeds to Operation 708. Alternatively, if the outgoing frame is not a partial frame (NO at Operation 704), the system proceeds to Operation 712. In an example, the system attempts to retrieve an outgoing frame from a frames decoder by executing a poll method that is offered by the frames decoder. If the poll method of the frames decoder returns an instance of a partial frame subclass in this example, the system concludes that the outgoing frame is a partial frame. Alternatively, if the poll method of the frames decoder returns an instance of a complete frame subclass or a malformed frame subclass in this example, the system concludes that the outgoing frame is not a partial frame.

In an embodiment, the system has determined that the outgoing frame is a partial frame, and the system decodes any undelivered payload data of the outgoing frame that is presently available for decoding (Operation 708). Example operations for decoding payload data of a partial frame are described below in Section 8 titled “Decoding Payload Data of a Partial Frame.” In an example, the outgoing frame's payload is or will be encoded in a continuous sequence of bytes presented by a buffers reader, and the system attempts to decode undelivered payload data of the outgoing frame that is encoded in the continuous sequence of bytes by executing a read payload bytes method that is offered by a frames decoder. In this example, the read payload bytes method is invoked on the frames decoder by the process method of the read loop. If the continuous sequence of bytes includes unread bytes in this example, the read payload bytes method of the frames decoder will generally return a list of one or more byte buffers representing any of those bytes that encode undelivered payload data of the outgoing frame. If the continuous sequence of bytes includes no unread bytes in this example, the read payload bytes method may return an empty list of byte buffers.

In an embodiment, the outgoing frame is a partial frame, and the system may deliver decoded payload data of the outgoing frame to a stream recipient (Operation 710). In some cases, there may be no decoded payload data that can presently be delivered (e.g., a read payload bytes method of a frames decoder returns an empty list of byte buffers). If there is payload data of the outgoing frame that can presently be delivered, the payload data is a portion of the outgoing frame's payload, or the payload data is the entirety of the outgoing frame's payload. It should be noted that modeling the outgoing frame as a partial frame may allow the system to deliver payload data of the outgoing frame to a stream recipient sooner because the system need not wait for the entirety of the outgoing frame to become available for decoding prior to beginning delivery of the payload data. The system delivers the payload data of the outgoing frame to a single recipient, or the system delivers the payload data of the outgoing frame to multiple recipients. Additionally, or alternatively, the system delivers frame metadata and/or other information to a stream recipient. A stream recipient that is delivered decoded data of the outgoing frame may be a component of the system, or the stream recipient may be external to the system.

In an embodiment, the system may determine appropriate stream recipient(s) for the decoded data of the outgoing frame based on (a) the frame type of the outgoing frame, (b) a protocol associated with the outgoing frame, (c) the content of the outgoing frame, and/or (d) other information. As an example, assume that the outgoing frame (i.e., the current partial frame) is an HTTP/3 data frame. In this example, the system delivers the payload data of the outgoing frame to an HTTP response subscriber (e.g., a streaming application, a web browser, an API client, a file downloader, a machine learning pipeline, etc.). There may be a single HTTP response subscriber in this example, or there may be multiple HTTP response subscribers. The system of this example delivers the payload data to an HTTP response subscriber by adding the payload data to a queue of stream data. In this example, the payload data of the outgoing frame is returned to the process method of the read loop as a list of byte buffers, and the queue of stream data is manifested as an instance of a concurrent linked queue class. The system of this example adds the payload data of the outgoing frame to the concurrent linked queue instance by executing an add method offered by the concurrent linked queue instance while specifying the list of byte buffers as an input parameter. After the payload data is added to the queue of stream data in this example, the system pushes that payload data to an HTTP response subscriber by executing a push response data method offered by the read loop. The HTTP response subscriber may subsequently consume this payload data when the HTTP response subscriber is ready to consume the payload data.

In an embodiment, the system may discard payload data of the outgoing frame if the outgoing frame is an unknown frame. As an example, assume that the outgoing frame (i.e., the partial frame) is an HTTP/3 frame with an unknown frame type. In this example, the outgoing frame is modeled as an unknown frame, and the system discards any payload data of the outgoing frame without delivering the payload data to a stream recipient.

In an embodiment, the outgoing frame is not a partial frame, and the system delivers data of the outgoing frame to a stream recipient (Operation 712). In this scenario, the outgoing frame is a complete frame, a malformed frame, or another variety of outgoing frame other than a partial frame. Depending on the characteristics of the outgoing frame and/or other factors, the data of the outgoing frame that is delivered to the recipient may include (a) the decoded payload data of the outgoing frame, (b) the decoded frame metadata of the outgoing frame, and/or (c) other information (e.g., an error code associated with a malformed frame). The system delivers the data of the outgoing frame (e.g., payload data, frame metadata, etc.) to a single recipient, or the system delivers the data of the outgoing frame to multiple recipients. A recipient that is delivered data of the outgoing frame may be a component of the system, or the recipient may be external to the system. If the outgoing frame is a malformed frame, delivery of the outgoing frame may trigger (a) termination of a stream that includes the outgoing frame, (b) termination of a network connection that is used to establish the stream, and/or (c) other responses. The system may determine appropriate recipient(s) for the data of the outgoing frame based on (a) the frame type of the outgoing frame, (b) a protocol associated with the outgoing frame, (c) the content of the outgoing frame, and/or (d) other information. As an example, assume that the outgoing frame is an HTTP/3 frame. For instance, the outgoing frame of this example may be a settings frame, a go away frame, a cancel push frame, a max push ID frame, or another variety of HTTP/3 frame. In this example, the system may deliver the frame metadata and/or payload data of the outgoing frame to an HTTP/3 connection handler, a stream manager, a connection-level push handler, and/or other recipient(s).

In an embodiment, the system ceases attempts to deliver outgoing frames (Operation 714). In this scenario, the attempt to retrieve an outgoing frame was unsuccessful because there was not enough information available to decode the next outgoing frame in the stream. Attempts to deliver outgoing frames may recommence once more information becomes available for decoding. In an example, the process method of the read loop transitions to polling a stream reader for additional buffers after the process method ceases attempts to deliver outgoing frames. In this example, the process method of the read loop may recommence attempts to deliver an outgoing frame if executing a poll method on the stream reader returns null. It should be noted that a poll method of a stream reader is distinct from a poll method of a frames decoder.

### 6. RETRIEVING AN OUTGOING FRAME

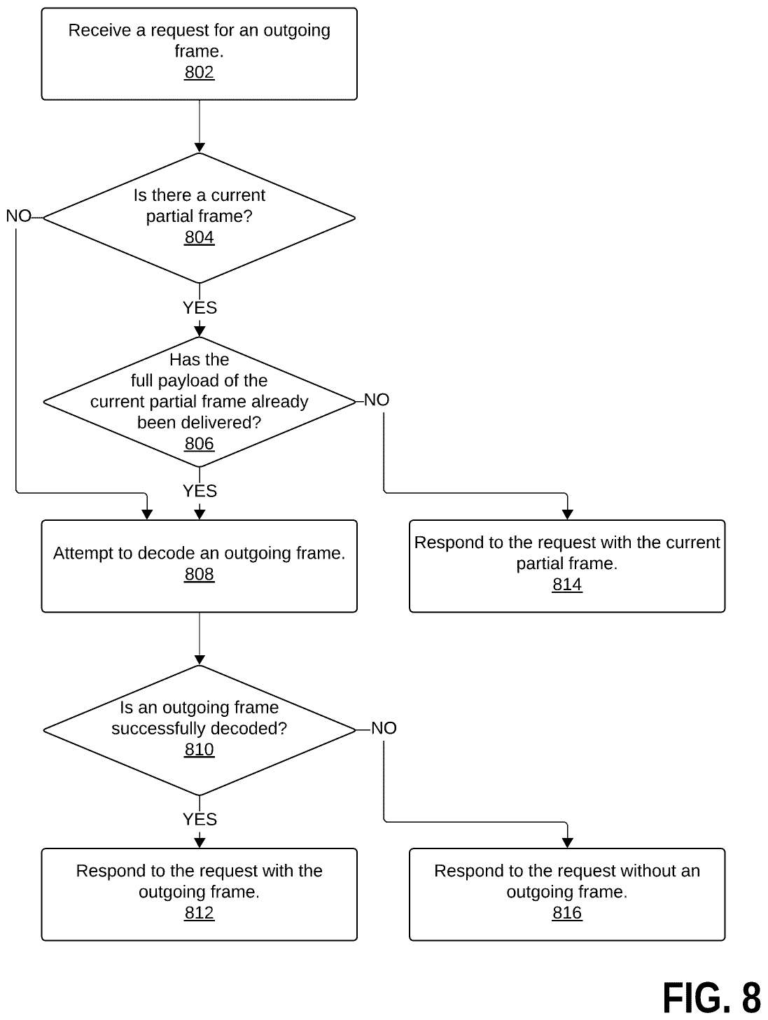

FIG. 8 illustrates an example set of operations for retrieving an outgoing frame in accordance with one or more embodiments. One or more operations illustrated in FIG. 8 may be modified, rearranged, or omitted. Accordingly, the particular sequence of operations illustrated in FIG. 8 should not be construed as limiting in accordance with one or more embodiments.

In an embodiment, the system receives a request for an outgoing frame (Operation 802). Hereafter, the request for the outgoing frame is referred to as the “poll request.” The poll request may originate from another component of the system. In an example, the poll request is an invocation of a poll method that is offered by a frames decoder. In this example, the poll method of the frames decoder is invoked by a process method of a read loop.

In an embodiment, the system determines if there is a partial frame that is currently being decoded (i.e., a current partial frame), and the system proceeds to another operation based on the determination (Operation 804). If there is a current partial frame (YES at Operation 804), the system proceeds to Operation 806. Alternatively, if there is not a current partial frame (NO at Operation 804), the system proceeds to Operation 808. In an example, the system determines if there is a current partial frame by inspecting a partial frame instance variable of a frames decoder. If the partial frame instance variable references a partial frame in this example, that partial frame is the current partial frame. Alternatively, if the current partial frame instance variable is set to null in this example, the system concludes that there is not a current partial frame.

In an embodiment, the system determines if the payload of the current partial frame has been fully delivered to a stream recipient, and the system proceeds to another operation based on the determination (Operation 806). If the payload of the current partial frame has been fully delivered to a stream recipient (YES at Operation 806), the system proceeds to Operation 808. Alternatively, if the payload of the current partial frame has not been fully delivered to a stream recipient (NO at Operation 806), the system proceeds to Operation 814. In an example, the system determines if the payload of the current partial frame has been fully delivered to a stream recipient by executing a remaining method that is offered by the current partial frame. If the remaining method of the current partial frame returns zero in this example, the system concludes that the current partial frame's payload has been fully delivered to a stream recipient. Alternatively, if the remaining method of the current partial frame returns a value greater than zero in this example, the system concludes that the current partial frame's payload includes undelivered payload data.

In an embodiment, the system attempts to decode an outgoing frame (Operation 808). Example operations for decoding an outgoing frame are described below in Section 7 titled “Decoding an Outgoing Frame.” In an example, the outgoing frame is encoded in a continuous sequence of bytes presented by a buffers reader, and the system attempts to decode the outgoing frame from the continuous sequence of bytes by executing a static decode method that is offered by an outgoing frame reference type. In this example, the decode method of the outgoing frame reference type is invoked by the poll method of the frames decoder, and the invocation of the poll method specifies the buffers reader and a predicate as input parameters.

In an embodiment, the system determines if the attempt to decode an outgoing frame is successful, and the system proceeds to another operation based on the determination (Operation 810). If the attempt to decode an outgoing frame is successful (YES at Operation 810), the system proceeds to Operation 812. Alternatively, if the attempt to decode an outgoing frame is not successful (NO at Operation 810), the system proceeds to Operation 816. In an example, the system attempts to decode an outgoing frame by executing a decode method of an outgoing frame reference type. In this example, the system concludes that the attempt to decode an outgoing frame is successful if the decode method returns an outgoing frame (e.g., a complete frame, a partial frame, a malformed frame, etc.). Otherwise, the system of this example concludes that the attempt to decode an outgoing frame is not successful (e.g., the decode method returns null).

In an embodiment, the system responds to the poll request with the newly decoded outgoing frame (Operation 812). In addition, if the outgoing frame is a partial frame, the system may set the outgoing frame as the new current partial frame. In an example, the poll request is an invocation of a poll method on a frames decoder. In this example, the poll method is invoked by a process method of a read loop, and the poll method returns the outgoing frame to the process method the read loop. If the outgoing frame is a partial frame in this example, the system sets the outgoing frame as the new current partial frame by updating a partial frame instance variable of the frames decoder, so the partial instance variable refers to the outgoing frame.

In an embodiment, the system responds to the poll request with the current partial frame (Operation 814). In this scenario, the current partial frame was found to include undelivered payload data, and there was no need for the system to attempt to decode a new outgoing frame. In an example, the poll request is an invocation of a poll method on a frames decoder. In this example, the poll method of the frames decoder is invoked by a process method of a read loop, and the poll method of the frames decoder returns the current partial frame to the process method of the read loop.

In an embodiment, the system responds to the poll request without an outgoing frame (Operation 816). In this scenario, the system attempted to decode a new outgoing frame; however, the attempt to decode an outgoing frame was unsuccessful. In an example, the poll request is an invocation of a poll method on a frames decoder. In this example, the poll method of the frames decoder is invoked by a process method of a read loop, and the poll method of the frames decoder returns null to the process method of the read loop.

### 7. DECODING AN OUTGOING FRAME

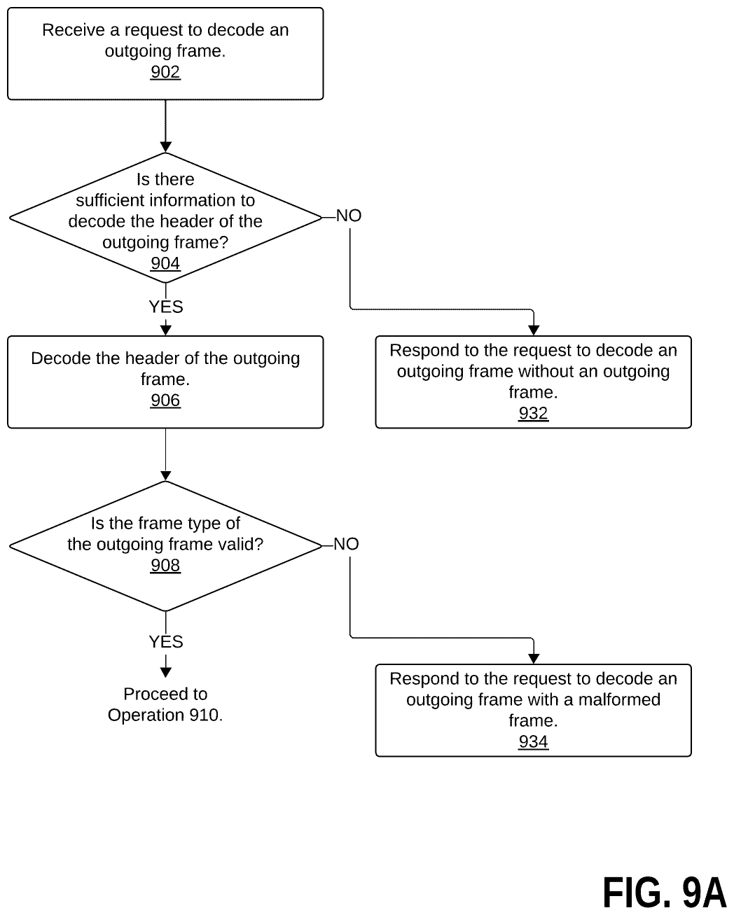

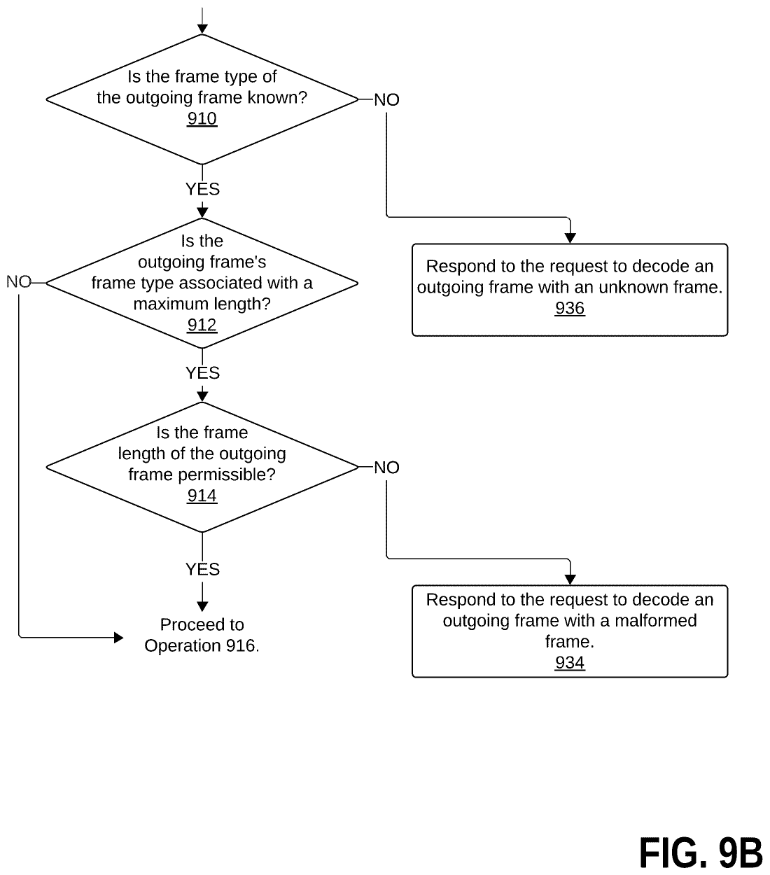

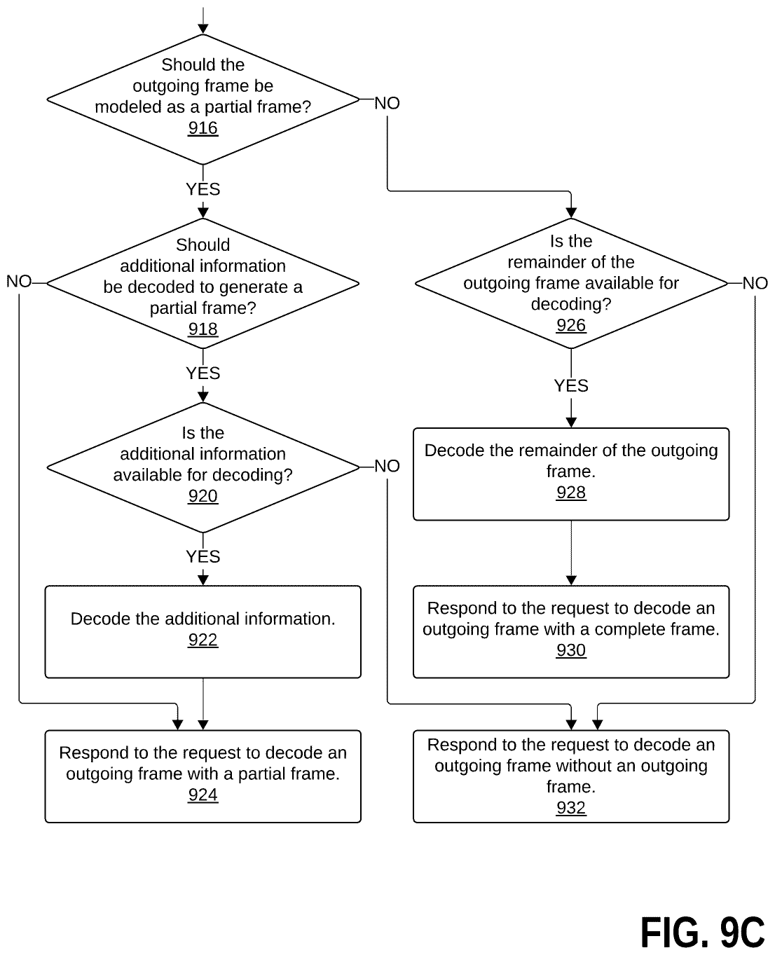

FIG. 9A, FIG. 9B, and FIG. 9C illustrate an example set of operations for decoding an outgoing frame in accordance with one or more embodiments. One or more operations illustrated in FIG. 9A, FIG. 9B, and/or FIG. 9C may be modified, rearranged, or omitted. Accordingly, the particular sequence of operations illustrated in FIG. 9A, FIG. 9B, and FIG. 9C should not be construed as limiting the scope of one or more embodiments.

In an embodiment, the system receives a request to decode an outgoing frame (Operation 902). Hereafter, the request to decode an outgoing frame is referred to as the “decode request.” The decode request may originate from another component of the system. In an example, the decode request is an invocation of a static decode method of an outgoing frame reference type. In this example, the decode method is invoked by a poll method of a frames decoder, and the invocation of the decode method specifies a buffers reader and a predicate as input parameters of the decode request. The buffers reader of this example presents a continuous sequence of bytes, and the outgoing frame is or will be encoded to the continuous sequence of bytes.

In an embodiment, the system determines if the header of the outgoing frame is presently available for decoding, and the system proceeds to another operation based on the determination (Operation 904). In other words, the system determines if there is enough information available to decode the header of the outgoing frame. The header of the outgoing frame includes information that can be used to determine how the outgoing frame should be modeled (e.g., as a complete frame, as a partial frame, as a malformed frame, etc.), and the system is more specifically determining if the relevant information in the header is presently available for decoding. In general, the information that is relevant to determining how the outgoing frame should be modeled may depend on (a) the protocol(s) associated with the outgoing frame, (b) the frame type of the outgoing frame, and/or (c) other factors. Example information that may be relevant to determining how the outgoing frame should be modeled includes (a) the frame type of the outgoing frame, (b) the frame length of the outgoing frames, and (c) other information. If the header of the outgoing frame is presently available for decoding (YES at Operation 904), the system proceeds to Operation 906. Alternatively, if the header of the outgoing frame is not presently available for decoding (NO at Operation 904), the system proceeds to Operation 932. In an example, the header of the outgoing frame is or will be encoded in a continuous sequence of bytes presented by a buffers reader, and the system determines if there is sufficient information available to decode the header of the outgoing frame based on the number of unread bytes presently included in the continuous sequence of bytes. In this example, the system may determine the number of unread bytes included within the continuous sequence of bytes by executing a remaining method offered by the buffers reader.

In an embodiment, the system decodes at least part of the outgoing frame's header (Operation 906). Specifically, the system decodes frame metadata included in the outgoing frame's header that is relevant to determining how the outgoing frame should be modeled. For example, the system may decode the frame type of the outgoing frame, and the system may decode the frame length of the outgoing frame. In this example, the header of the outgoing frame is encoded within a continuous sequence of bytes presented by a buffers reader, and the system decodes the frame type and the frame length by retrieving bytes within the continuous sequence of bytes that encode the header of the outgoing frame. The system of this example retrieves the bytes encoding the header by peeking through the buffers reader (e.g., by executing an absolute get method offered by the buffers reader). Additionally, or alternatively, the system of this example retrieves the bytes encoding the header by reading through the buffers reader (e.g., by executing a relative get method offered by the buffers reader). It should be noted that if the system retrieves the bytes encoding the header of the outgoing frame by peeking through the buffers reader, the system may need to alter the read position of the buffers reader manually in a subsequent operation.

In an embodiment, the system determines if the frame type of the outgoing frame is valid, and the system proceeds to another operation based on the determination (Operation 908). In general, the criteria for determining if the frame type of the outgoing frame is valid may depend on the protocol that is associated with the outgoing frame and other factors. If the frame type of the outgoing frame is valid (YES at Operation 908), the system proceeds to Operation 910. Alternatively, if the frame type of the outgoing frame is not valid (NO at Operation 908), the system proceeds to Operation 934. In an example, the system determines the validity of the frame type of the outgoing frame by executing a predicate method that was specified as an input parameter of the decode request. In this example, the predicate method is invoked by the process method of the outgoing frame reference type, and the invocation of the predicate method specifies the frame type of the outgoing frame as an input parameter.

In an embodiment, the system determines if the frame type of the outgoing frame is a known frame type, and the system proceeds to another operation based on the determination (Operation 910). If the frame type of the outgoing frame is a known frame type (YES at Operation 910), the system proceeds to Operation 912. Alternatively, if the frame type of the outgoing frame is an unknown frame type (NO at Operation 910), the system proceeds to Operation 936. In an example, the system determines if the frame type is a known frame type by executing a static for type method of a frame type class. In this example, the for type method of the frame type class is invoked by the decode method of the outgoing frame reference type, and the invocation of the for type method specifies the frame type of the outgoing frame as an input parameter.

In an embodiment, the system determines if the frame type of the outgoing frame is associated with a maximum length, and the system proceeds to another operation based on the determination (Operation 912). In other words, the system is determining if the frame length of the outgoing frame is constrained to a maximum length. If the frame length of the outgoing frame is constrained to a maximum length (YES at Operation 912), the system proceeds to Operation 914. Alternatively, if the frame length of the outgoing frame is not limited to a maximum length (NO at Operation 912), the system proceeds to Operation 916. In an example, the system determines if the frame type of the outgoing frame is associated with a maximum length by executing a static max length method of a frame type class. In this example, the max length method of the frame type class is invoked by the decode method of the outgoing frame reference type, and the invocation of the max length method specifies the frame type of the outgoing frame as an input parameter.

In an embodiment, the system determines if the frame length of the outgoing frame is permissible, and the system proceeds to another operation based on the determination (Operation 914). The frame length of the outgoing frame is permissible if the frame length is equal to or less than the maximum length of the outgoing frame. If the frame length of the outgoing frame is equal to or less than the maximum length of the outgoing frame (YES at Operation 914), the system proceeds to Operation 916. Alternatively, if the frame length of the outgoing frame is greater than the maximum length of the outgoing frame (NO at Operation 914), the system proceeds to Operation 934.

In an embodiment, the system determines if the outgoing frame should be modeled as a partial frame, and the system proceeds to another operation based on the determination (Operation 916). If the system concludes that the outgoing frame should be modeled as a partial frame (YES at Operation 916), the system proceeds to Operation 918. Alternatively, if the system concludes that the outgoing frame should not be modeled as a partial frame (NO at Operation 916), the system proceeds to Operation 926. Example information that may influence determining if the outgoing frame should be modeled as a partial frame includes (a) the frame type of the outgoing frame, (b) the frame length of the outgoing frame, (c) a protocol associated with the outgoing frame, (d) the content of the outgoing frame, (c) memory and processing resources available to the system, (f) the amount of unconsumed data that has already been delivered to the stream recipient, and (g) other factors. The system determines how the outgoing frame should be modeled based on a single criterion, or the system determines how the outgoing frame should be modeled based on multiple criteria.

In an embodiment, the system may determine if the outgoing frame should be modeled as a partial frame based on the frame type of the outgoing frame. In general, protocol frames that have variable-length payloads are often more suitable for being modeled as partial frames. In contrast, protocol frames that have fixed-length payloads are often more suitable for being modeled as a complete frame. Whether or not a protocol frame can include a variable-length payload may be determined based on the protocol frame's frame type. Thus, if the outgoing frame's frame type indicates that the outgoing frame may have a variable-length payload, the system may conclude that the outgoing frame should be modeled as a partial frame. Alternatively, if the outgoing frame's frame type indicates that the outgoing frame has a fixed-length payload, the system may conclude that the outgoing frame should be modeled as a complete frame. In an example, the outgoing frame is an HTTP/3 frame, and the system models the outgoing frame as a partial frame if the outgoing frame is (a) a headers frame, (b) a data frame, (c) a push promise frame, or (d) another type of HTTP/3 frame with a variable-length payload. Alternatively, the system of this example models the outgoing frame as a complete frame if the outgoing frame is (a) a settings frame, (b) a go away frame, (c) a cancel push frame, (d) a max push ID frame, or (e) another type of HTTP/3 frame with a fixed-length payload.

In an embodiment, the system may determine if the outgoing frame should be modeled as a partial frame based on the frame length of the outgoing frame. In an example, the system determines that the outgoing frame should be modeled as a partial frame if the frame length of the outgoing frame meets or exceeds a threshold frame length. Alternatively, if the frame length of the outgoing frame is below the threshold frame length, the system of this example concludes that the outgoing frame should not be modeled as a partial frame.

In an embodiment, the system determines if additional information should be decoded prior to generating a partial frame, and the system proceeds to another operation based on the determination (Operation 918). At present, the system has already decoded the frame type of the outgoing frame and the frame length of the outgoing frame. In some cases, the frame type and the frame length are sufficient information for modeling the outgoing frame as a partial frame. In other cases, additional information (e.g., additional frame metadata) may need to be decoded before generating a partial frame. In general, if additional information should be decoded may depend on (a) the frame type of the outgoing frame, (b) the protocol of the outgoing frame, and/or (c) other factors. If the system concludes that additional information should be decoded prior to generating the partial frame (YES at Operation 918), the system proceeds to Operation 920. Alternatively, if the system concludes that decoding additional information is unwarranted (NO at Operation 918), the system proceeds to Operation 924. In an example, the outgoing frame is an HTTP/3 push promise frame, and the system concludes that additional frame metadata should be decoded from the header of the outgoing frame prior to generating a partial frame. In this example, the header of the HTTP/3 push promise frame includes a push ID, and the system will decode the push ID so that the push ID can be included in the partial frame that models the outgoing frame. In another example, the outgoing frame is an HTTP/3 data frame, and the system concludes that the frame length and the frame type are sufficient information to generate a partial frame.

In an embodiment, the system determines if the additional information that should be decoded prior to generating the partial frame is presently available for decoding, and the system proceeds to another operation based on the determination (Operation 920). If the additional information is presently available for decoding (YES at Operation 920), the system proceeds to Operation 922. Alternatively, if the additional information is not presently available for decoding (NO at Operation 920), the system proceeds to Operation 932. In an example, the additional information is or will be encoded in a continuous sequence of bytes presented by a buffers reader, and the system determines if the additional information is available for decoding based on a number of unread bytes included in the continuous sequence of bytes.

In an embodiment, the system decodes the additional information (Operation 922). In an example, the additional information is included in a continuous sequence of bytes presented by a buffers reader, and the system decodes the additional information by retrieving those bytes from the buffers reader. The system of this example retrieves these bytes by peeking through the buffers reader (e.g., by executing an absolute get method offered by the buffers reader), or the system of this example retrieves these bytes by reading through the buffers reader (e.g., by executing a relative get method offered by the buffers reader).

In an embodiment, the system responds to the decode request with a partial frame (Operation 924). In an example, the decode request is an invocation of a decode method that is offered by an outgoing frame reference type. In this example, the decode request is invoked by a process method of a frames decoder, and the decode method returns the partial frame to the process method of the frames decoder. The partial frame of this example is an instance of a partial frame subclass corresponding to the frame type of the outgoing frame. In addition to returning the partial frame in this example, the system may update a read position of the buffers reader as needed to mark the bytes encoding information that is used to generate the partial frame (e.g., the header of the outgoing frame) as being read (e.g., by executing a position method offered by the buffers reader while specifying a new read position as an input parameter). Once these bytes have been designated as read, the system of this example may release any read bytes from the continuous sequence of bytes presented by the buffers reader (e.g., by executing a release method offered by the buffers reader).

In an embodiment, the system determines if the remainder of the outgoing frame is presently available for decoding, and the system proceeds to another operation based on the determination (Operation 926). In this scenario, the system has concluded that the outgoing frame should not be modeled as a partial frame. If the remainder of the outgoing frame can presently be decoded (YES at Operation 926), the system proceeds to Operation 928. Alternatively, if the remainder of the outgoing frame is not presently available for decoding (NO at Operation 926), the system proceeds to Operation 932. In an example, the remainder of the outgoing frame is or will be encoded in a continuous sequence of bytes presented by a buffers reader, and the system determines if the remainder of the outgoing frame is presently available for decoding based on (a) the frame length of the outgoing frame, (b) the number of unread bytes included in the continuous sequence of bytes, and/or (c) other information. If the number of unread bytes included in the continuous sequence of bytes is insufficient to encode the entire remainder of the outgoing frame, the system concludes that the remainder of the outgoing frame cannot presently be decoded.

In an embodiment, the system decodes the remainder of the outgoing frame to generate a complete frame (Operation 928). In an example, the remainder of the outgoing frame is encoded to a continuous sequence of bytes presented by a buffers reader. In this example, the system decodes the remainder of the outgoing frame by executing a decode frame method that is offered by a complete frame subclass that corresponds to the frame type of the outgoing frame. For instance, if the frame type of the outgoing frame is a settings frame in this example, the decode method of the outgoing frame reference type invokes a decode frame method of a settings frame subclass, and the invocation of the decode frame method specifies the buffers reader as an input parameter. After generating the complete frame in this example, the system may update the read position of the buffers reader to designate the bytes encoding the complete frame as read (e.g., by executing a position method offered by the buffers reader while specifying a new read position as an input parameter), and the system may release read bytes from the continuous sequence of bytes presented by the buffers reader (e.g., by executing a release method offered by the buffers reader).

In an embodiment, the system responds to the decode request with a complete frame (Operation 930). In an example, the decode request is an invocation of a decode method that is offered by an outgoing frame reference type. In this example, the decode request is invoked by a process method of a frames decoder, and the decode method returns the complete frame to the process method of the frames decoder.

In an embodiment, the system responds to the decode request without an outgoing frame (Operation 932). In this scenario, the system ceases the attempt to decode the outgoing frame because (a) there is not enough information available to generate a partial frame and/or (b) there is not enough information available to generate a complete frame. In an example, the decode request is an invocation of a decode method that is offered by an outgoing frame reference type. In this example, the decode request is invoked by a process method of a frames decoder, and the decode method returns null to the process method of the frames decoder.

In an embodiment, the system responds to the decode request with a malformed frame (Operation 934). In this scenario, the outgoing frame is modeled as a malformed frame because (a) the frame type of the outgoing frame is invalid, (b) the frame length of the outgoing frame is impermissible, and/or (c) there is some other error associated with the outgoing frame. As a result of modeling the outgoing frame as a malformed frame, the system may trigger a protocol error, and the protocol error may result in (a) termination of a stream that includes the outgoing frame, (b) termination of the network connection that is used to establish the stream, and/or (c) other reactions. In an example, the decode request is an invocation of a decode method that is offered by an outgoing frame reference type. In this example, the decode request is invoked by a process method of a frames decoder, and the decode method returns the malformed frame to the process method of the frames decoder.

In an embodiment, the system responds to the decode request with an unknown frame (Operation 936). In addition, the system may discard the payload of the outgoing frame without delivering the payload of the outgoing frame to a stream recipient. In an example, the decode request is an invocation of a decode method that is offered by an outgoing frame reference type. In this example, the decode request is invoked by a process method of a frames decoder, and the decode method returns the unknown frame to the process method of the frames decoder. Furthermore, in this example, the system discards the payload of the outgoing frame by (a) marking the bytes within the continuous sequence of bytes presented by the buffers reader as read and (b) releasing read bytes from the continuous sequence of bytes.

### 8. DECODING PAYLOAD DATA OF A PARTIAL FRAME

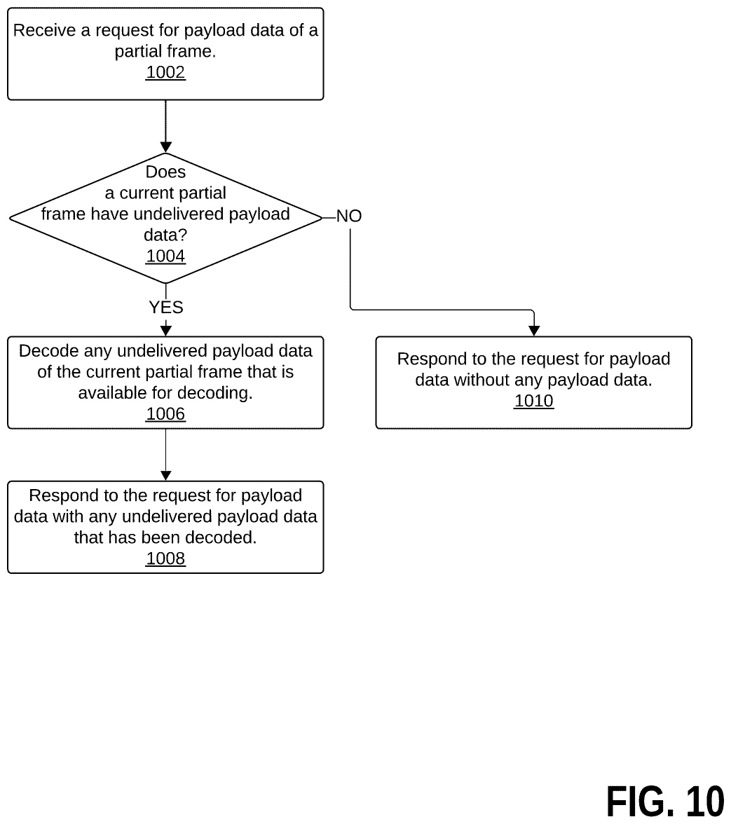

FIG. 10 illustrates an example set of operations for decoding payload data of an outgoing frame in accordance with one or more embodiments. One or more operations illustrated in FIG. 10 may be modified, rearranged, or omitted. Accordingly, the particular sequence of operations illustrated in FIG. 10 should not be construed as limiting in accordance with one or more embodiments.

In an embodiment, the system receives a request for undelivered payload data of a partial frame (Operation 1002). Hereafter, the request for undelivered payload data of the partial frame is referred to as the “payload request.” The payload request may originate from another component of the system. In an example, the undelivered payload data is or will be encoded in a continuous sequence of bytes presented by a buffers reader, and the payload request is an invocation of a read payload bytes method that is offered by a frames decoder. In this example, the read payload bytes method of the frames decoder is invoked by a process method of a read loop.

In an embodiment, the system determines if there is a current partial frame with undelivered payload data, and the system proceeds to another operation based on the determination (Operation 1004). If there is a current partial frame with undelivered payload data (YES at Operation 1004), the system proceeds to Operation 1006. Alternatively, if there is not a current partial frame with undelivered payload data (NO at Operation 1004), the system proceeds to Operation 1010. In an example, the system determines if there is a current partial frame with undelivered payload data by executing a remaining method offered by the current partial frame. The system of this example identifies the current partial frame based on a partial frame instance variable of a frames decoder. The partial frame instance variable references the current partial frame of this example. If the remaining method of the current partial returns a value greater than zero, the system of this example invokes a next payload bytes method that is offered by the current partial frame (i.e., the system proceeds to Operation 1006). In this example, the next payload bytes method of the partial frame is invoked by the read payload bytes method of the frames decoder, and the invocation of the read payload bytes method specifies, as an input parameter, a buffers reader that presents a continuous sequence of bytes that presently encodes or will encode the undelivered payload data.

In an embodiment, the system decodes any undelivered payload data of the current partial frame that is presently available for decoding (Operation 1006). In this scenario, there may or may not be undelivered payload data that is presently available for decoding. In an example, the undelivered payload data of the current partial frame is encoded into a continuous sequence of bytes presented by a buffers reader, and the system retrieves the undelivered payload data by executing a get and release method that is offered by the buffers reader. In this example, the get and release method of the buffers reader is invoked by the next payload bytes method of the current partial frame, and the invocation of the get and release method specifies a number of bytes as an input parameter. If the entire remainder of the current partial frame's payload is presently available for decoding in this example, the number of bytes specified as an input parameter to the get and release method is equal to the number of bytes encoding the entire remainder of the partial frame's payload (i.e., the value returned by the remaining method of the current partial frame). If a portion of the undelivered payload data of the current partial frame is presently available for decoding in this example, the number of bytes specified as an input parameter to the get and release method is equal to the number of unread bytes included in the continuous sequence of bytes presented by the buffers reader. The system of this example may determine the number of unread bytes included in the continuous sequence of bytes by executing a remaining method offered by the buffers reader. In this example, the get and release method of the buffers reader returns any bytes encoding the undelivered payload data to the next payload bytes method of the current partial frame. The get and release method of the buffers reader in this example returns any bytes encoding undelivered payload data to the next payload bytes method of the current partial frames as a list of byte buffers. If the continuous sequence of bytes presented by the buffers reader does not include any unread bytes in this example (i.e., no part of the undelivered payload data is presently available for decoding), the list of byte buffers is returned as an empty list.

In an embodiment, the system responds to the payload request with any undelivered payload data that has been decoded (Operation 1008). In an example, the payload request is an invocation of a read payload bytes method that is offered by a frames decoder, and the read payload bytes method of the frames decoder is invoked by a process method of a read loop. In this example, the read payload bytes method of the frames decoder returns any undelivered payload data that has now been decoded to the process method of the read loop as a list of byte buffers. If no undelivered payload data was available for decoding in this example, the list of byte buffers is empty.

In an embodiment, the system responds to the payload request without any payload data (Operation 1010). In this scenario, the system ceases the attempt to decode payload data because there is not a current partial frame with undelivered payload data remaining. In an example, the payload request is an invocation of a read payload bytes method that is offered by a frames decoder, and the read payload bytes method of the frames decoder is invoked by a process method of a read loop. In this example, the read payload bytes method of the frames decoder returns null to the process method of the read loop.

### 9. EXAMPLE EMBODIMENT

A detailed example is described below for purposes of clarity. Components and/or operations described below should be understood as one specific example that may not be applicable to certain embodiments. Accordingly, components and/or operations described below should not be construed as limiting the scope of any of the claims.

### 9.1 Example Packet Architecture

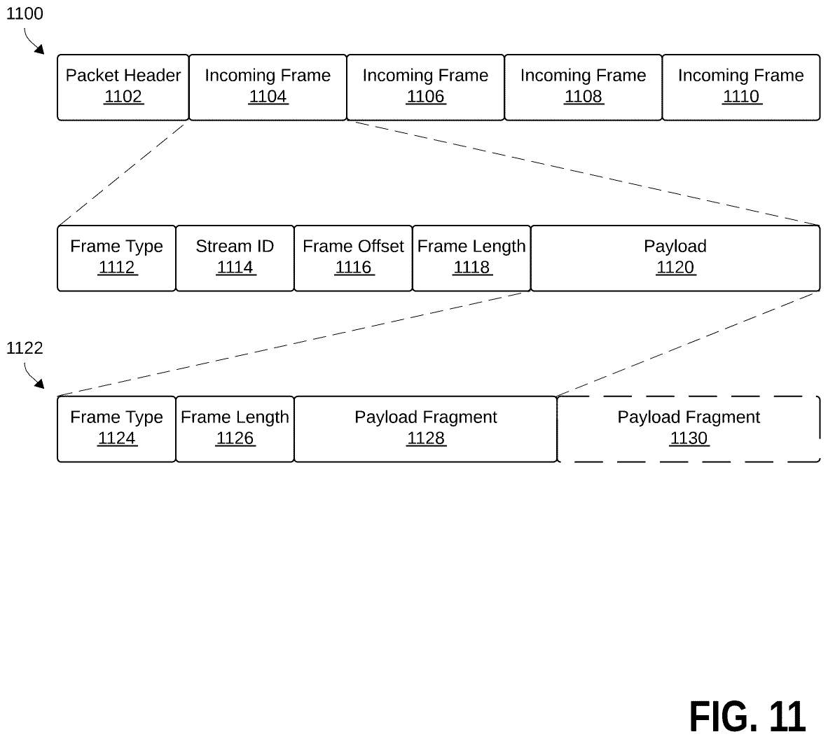

FIG. 11 illustrates a packet 1100 that is transmitted to the system through a network connection in accordance with an example embodiment. As illustrated in FIG. 11, packet 1100 includes packet header 1102, incoming frame 1104, incoming frame 1106, incoming frame 1108, and incoming frame 1110. A packet may include more or fewer components than packet 1100 as illustrated in FIG. 11.

In an example embodiment, packet 1100 is delivered to the system embedded in other unit(s) of stream data. For the purposes of the example illustrated by FIG. 11, assume that packet 1100 is transmitted to the system in accordance with the QUIC protocol. In this example, packet 1100 is a QUIC packet. As noted previously, the QUIC protocol is built on top of UDP. Accordingly, packet 1100 may be delivered to the system included within a UDP packet. A UDP packet that includes packet 1100 may include other QUIC packets. In this example, packet 1100 may be delivered to the system in an incorrect sequence relative to other packets of the same stream.

In an example embodiment, packet 1100 includes packet header 1102, and packet 1100 includes multiple incoming frames. Packet 1100 delivers incoming frames of a single stream, or packet 1100 delivers incoming frames of multiple streams. An incoming frame included in packet 1100 may be a portion of an incoming frame, and a remainder of this incoming frame may be split into one or more other packets.

In an example embodiment, packet header 1102 specifies packet metadata that is used to route packet 1100 to the system. Example packet metadata that may be specified within packet header 1102 includes a header type, a fixed bit, a spin bit, reserved bits, a key phase, a packet number length, a destination connection ID, and/or other information.

In an example embodiment, incoming frame 1102, incoming frame 1104, incoming frame 1106, incoming frame 1108, and incoming frame 1110 are protocol frames. In the example illustrated by FIG. 11, incoming frame 1102, incoming frame 1104, incoming frame 1106, incoming frame 1108, and incoming frame 1110 are QUIC frames. Incoming frame 1102, incoming frame 1104, incoming frame 1106, incoming frame 1108, and incoming frame 1110 belong to one or more streams that are established over the network connection that is used to deliver packet 1100 to the system.

In an example embodiment, an incoming frame is a protocol frame that delivers stream data to the system. In the example illustrated by FIG. 11, incoming frame 1104 is a QUIC stream frame. Accordingly, incoming frame 1104 includes a frame type 1112, a stream ID 1114, a frame offset 1116, a frame length 1118, and a payload 1120. An incoming frame may include more or fewer components than the components of incoming frame 1104 as illustrated in FIG. 11. For instance, if incoming frame 1104 is a different frame type than incoming frame 1106, incoming frame 1104 may include more or fewer components than incoming frame 1106.

In an example embodiment, frame type 1112 is binary data that indicates attributes of incoming frame 1104. In the example illustrated by FIG. 11, frame type 1112 indicates that (a) incoming frame 1104 is a QUIC stream frame, (b) incoming frame 1104 includes an offset field (i.e., frame offset 1116), (c) incoming frame 1104 includes a length field (i.e., frame length 1118), and (d) incoming frame 1104 is not the final frame of a stream.

In an example embodiment, stream ID 1114 is binary data that specifies the identify of a stream that incoming frame 1104 is included in. Recall that packet 1100 may carry incoming frames corresponding to multiple streams. Accordingly, stream ID 1114 may identify a different stream than the stream ID specified in the header of another incoming frame included within packet 1100. For instance, incoming frame 1104 corresponds to the same stream as incoming frame 1106, or incoming frame 1104 corresponds to a different stream than incoming frame 1106.

In an example embodiment, frame offset 1116 is binary data indicating the position of payload 1120 within the stream that is identified by stream ID 1114. In particular, frame offset 1116 indicates a starting position of payload 1120. In the example illustrated by FIG. 11, frame offset 1116 is a byte offset. In other words, frame offset 1116 specifies the address of a byte in this example.

In an example embodiment, frame length 1118 is binary data indicating the size of payload 1120. In the example illustrated by FIG. 11, frame length 1118 specifies a number of bytes occupied by payload 1120.

In an example embodiment payload 1120 is binary stream data of the stream that is identified by stream ID 1114. In the example illustrated by FIG. 11, payload 1120 includes a portion of an outgoing frame 1122. In particular, payload 1120 includes the header of outgoing frame 1122 (i.e., frame type 1124 and frame length 1126), and payload 1120 includes a portion of the outgoing frame's 1122 payload (i.e., payload fragment 1128).

In an example embodiment, outgoing frame 1122 is a protocol frame carrying a payload of stream data that is intended for a stream recipient. In the example illustrated by FIG. 11, outgoing frame 1122 is an HTTP/3 data frame. Accordingly, outgoing frame 1122 includes frame type 1124, frame length 1126, and a payload (i.e., payload fragment 1128 and payload fragment 1130). Outgoing frame 1122 is an example of a protocol frame that may be modeled as a partial frame. However, it should be noted that a protocol frame need not be fragmented across multiple units of stream data for that protocol frame to be modeled as a partial.

In an example embodiment, frame type 1124 is binary data that indicates attributes of partial outgoing frame 1120. In the example illustrated by FIG. 11, frame type 1124 indicates that outgoing frame 1122 is an HTTP/3 data frame.

In an example embodiment, frame length 1126 is binary data indicating the size of outgoing frame's 1122 payload. In other words, frame length 1126 indicates the combined size of both payload fragment 1128 and payload fragment 1130. In the example illustrated by FIG. 11, frame length 1126 indicates a number of bytes.

In an example embodiment, payload fragment 1128 and payload fragment 1130 are the payload of outgoing frame 1122. In the example illustrated by FIG. 11, the payload of outgoing frame 1122 is a variable-length sequence of bytes associated with HTTP response or response content. As illustrated by FIG. 11, payload fragment 1128 is included within the payload 1120 of incoming frame 1104; however, payload fragment 1130 is not included within the payload 1120 of incoming frame 1104. In this example, payload fragment 1130 has been or will be delivered to the system in another unit of stream data. Payload fragment 1130 may be included in another incoming frame within packet 1100, or payload fragment 1130 may be included in a separate packet altogether.

### 9.2 Example Payload Data Delivery

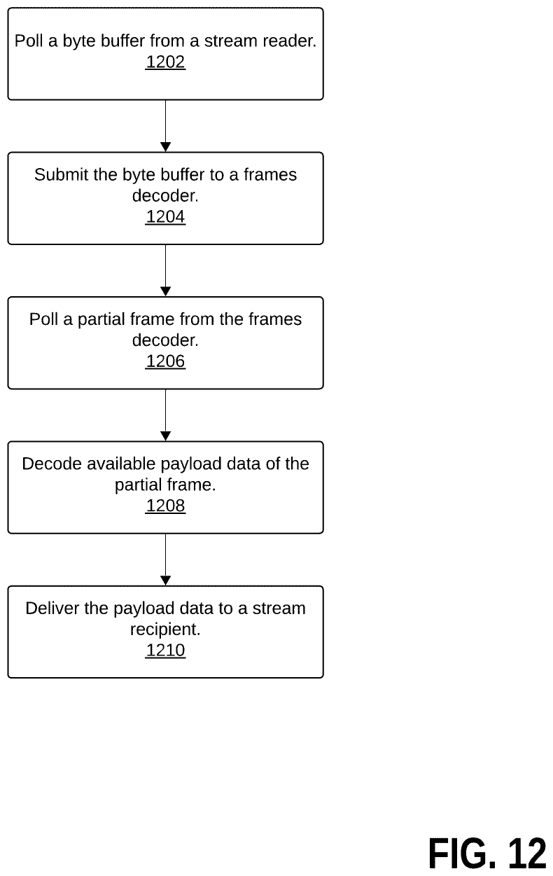

FIG. 12 illustrates an example set of operations for delivering payload data of an outgoing frame to a stream recipient. In particular, FIG. 12 illustrates an example set of operations for delivering payload fragment 1128 (as illustrated in FIG. 11) to a stream recipient.

In an example embodiment, the system polls a byte buffer representing payload 1120 of incoming frame 1104 from a queue of byte buffers maintained by a stream reader while the system is executing a process QUIC data method of a read loop (Operation 1202). The system retrieves the byte buffer by executing a poll method offered by the stream reader. The poll method of the stream reader is invoked by the process QUIC data method of the read loop. For the purposes of this example, assume that the byte buffer representing payload 1120 is the only byte buffer presently included in the queue of byte buffers maintained by the stream reader.

In an example embodiment, the system submits the byte buffer representing payload 1120 of incoming frame 1104 to a frames decoder while the system is executing the process QUIC data method of the read loop (Operation 1204). The system submits the byte buffer to the frames decoder by executing a submit method offered by the frames decoder. The submit method of the frames decoder is invoked by the process QUIC data method of the read loop, and the invocation of the submit method specifies the byte buffer representing payload 1120 of incoming frame 1104 as an input parameter. While executing the submit method of the frames decoder, the system adds the byte buffer representing the payload 1120 of incoming frame 1104 to a buffers reader. The system adds the byte buffer representing the payload 1120 of incoming frame 1104 to the buffers reader by executing an add method offered by the buffers reader. The add method of the buffers reader is invoked by the submit method of the frames decoder, and the invocation of the add method specifies the byte buffer representing the payload 1120 of incoming frame 1104 as an input parameter. While executing the add method of the buffers reader, the system generates an entry in a list of abstracted byte buffers corresponding to the byte buffer representing the payload 1120 of incoming frame 1104. The payload 1120 of incoming frame 1104 is now presented in a continuous sequence of bytes that is accessible through the buffers reader. In other words, frame type 1124, frame length 1126, and payload fragment 1128 are now presented in unread bytes of the continuous sequence of bytes. After submitting the byte buffer representing the payload 1120 of incoming frame 1104 to the frames decoder, the system attempts to poll additional byte buffers from the stream reader. However, in this example, there are no other byte buffers in the queue of byte buffers maintained by the stream reader. Therefore, the process QUIC data method of the read loop dictates that the system transition to polling the frames decoder for outgoing frames.

In an example embodiment, the system polls a partial frame representing outgoing frame 1122 from the frames decoder while the system is executing the process QUIC data method of the read loop (Operation 1206). The system polls the partial frame from the frames decoder by executing a poll method offered by the frames decoder. The poll method of the frames decoder is invoked by the process QUIC data method of the read loop. While the system is executing the poll method of the frames decoder, the system determines that there is not a current partial frame because a partial frame instance variable of the frames decoder is set to null. Accordingly, the system attempts to decode a new outgoing frame by executing a static decode method that is offered by an outgoing frame interface. The decode method of the outgoing frame interface is invoked by the poll method of the frames decoder, and the invocation of the decode method specifies the buffers reader and a predicate as input parameters. While executing the decode method of the outgoing frame interface, the system determines if the continuous sequence of bytes presented by the buffers reader includes sufficient information to decode the header of the outgoing frame 1122 (i.e., frame type 1124 and frame length 1126). For the purposes of this example, assume that (a) the continuous sequence of bytes presently includes frame type 1124, frame length 1126, and payload fragment 1128 in unread bytes and (b) the continuous sequence of bytes presently includes no other bytes. The system determines if continuous sequence of bytes presented by the buffers reader includes sufficient information to decode the header of outgoing frame 1122 by executing a remaining method that is offered by the buffers reader. The remaining method of the buffers reader is invoked by the decode method of the outgoing frame interface. The remaining method of the buffers reader returns the number of unread bytes presently included in the continuous sequence of bytes (i.e., the number of bytes encoding frame type 1124, frame length 1126, and payload fragment 1128). Based on the number of bytes returned by the remaining method of the buffers reader, the system, while executing the decode method of the outgoing frame interface, concludes that there is sufficient information to decode the header of outgoing frame 1122. Accordingly, the system decodes the frame type 1124 and frame length 1126 by pecking through the buffers reader (e.g., by executing an absolute get method offered by the buffers reader). The system subsequently determines if frame type 1124 is a valid frame type by executing the predicate method that was specified as an input parameter to the invocation of decode method. The predicate method is invoked by the decode method of the outgoing frame interface, and the invocation of the predicate method specifies frame type 1124 as an input parameter. After determining that the frame type 1124 is a valid frame type, the system determines if frame type 1124 is a known frame type while executing the decode method. The system determines if the frame type 1124 is a known frame type by executing a for type method offered by a frame type class. The for type method is invoked by the decode method of the outgoing frame interface, and the invocation of the for type method specifies frame type 1124 as an input parameter. In this example, the outgoing frame is an HTTP/3 data frame, and an HTTP/3 data frame is a known frame type. The system determines if the outgoing frame is constrained by a maximum length by executing a max length method that is offered by the frame type class. The max length method is invoked by the decode method, and the invocation of the decode method specifies frame type 1124 as an input parameter. HTTP/3 data frames do not have a maximum length. Thus, the system concludes that frame length 1126 does not exceed a maximum frame length. In this example, the system concludes that outgoing frame 1122 should be modeled as a partial frame because HTTP/3 data frames have variable-length payloads. Due to outgoing frame 1122 being an HTTP/3 data frame, there is no other information that needs to be decoded by the system to generate a partial frame apart from the frame type 1124 and the frame length 1126. Accordingly, the system generates an instance of a data frame subclass that extends a partial frame class. In addition, the system updates the read position of the buffers reader to designate the bytes encoding frame type 1124 and frame length 1126 as having been read (e.g., by executing a position method offered by the frames decoder while specifying a new read position as an input parameter). The decode method of the outgoing frame interface returns the data frame instance to the poll method of the frames decoder, and the poll method of the frames decoder updates the partial frame instance variable of the frames decoder so that the partial frame instance variable refers to the data frame instance. Accordingly, outgoing frame 1122 is now the current partial frame. The poll method of the frames decoder returns the data frame instance to the process QUIC data method of the read loop.

In an example embodiment, the system decodes payload fragment 1128 while the system is executing the process QUIC data method of the read loop (Operation 1208). The system decodes payload fragment 1128 by executing a read payload bytes method offered by a frames decoder. The read payload bytes method of the frames decoder is invoked by the process QUIC data method of the read loop. While the system is executing the read payload bytes method of the frames decoder, the system verifies that outgoing frame 1122 has undelivered payload data remaining. The system verifies that outgoing frame 1122 has undelivered payload data remaining by executing a remaining method that is offered by the data frame instance representing outgoing frame 1122. The read payload bytes method of the frames decoder accesses the data frame instance through the reference held by the partial frame instance variable of the frames decoder. The remaining method of the data frame instance is invoked by the read payload bytes method of the frames decoder. The remaining method of the data frame instance is configured to return the value that is held by a remaining variable of the data frame instance. In this example, no payload data of outgoing frame 1122 has been delivered thus far. Accordingly, the remaining method of the data frame instance returns a number of bytes equal to the frame length 1126. After verifying that outgoing frame 122 has undelivered payload data remaining, the system executes a next payload bytes method that is offered by the data frame instance. The next payload bytes method of the data frame instance is invoked by the read payload bytes method of the frames decoder, and the invocation of the next payload bytes method specifies the buffers reader as an input parameter. While executing the next payload bytes method, the system determines if the continuous sequence of bytes presented by buffers reader includes unread bytes by executing a remaining method offered by the buffers reader. The remaining method of the buffers reader is invoked by the next payload bytes method of the data frame instance. In this example, the remaining method of the buffers reader returns the number of bytes encoding payload fragment 1128. After verifying that the continuous sequence of bytes presented by the buffers readers includes unread bytes, the system decodes payload fragment 1128 from the continuous sequence of bytes by executing a get and release method offered by the buffers reader. The get and release method of the buffers reader is invoked by the next payload bytes method of the data frame instance. In this example, the remaining method of the buffers reader returned a smaller value than the remaining method of the data frame instance. Therefore, the invocation of the get and release method specifies the value returned by the remaining method of the buffers reader as an input parameter (i.e., the number of bytes encoding payload fragment 1128). The get and release method of the buffers reader returns a list of byte buffers to the next payload bytes method. In this example, the list of byte buffers includes the byte buffer that represents payload 1120 of incoming frame 1104. While executing the next payload bytes method, the system updates the remaining variable of the data frame instance to reduce the number of bytes held by the remaining variable by the number of bytes that are read from the continuous sequence of bytes while executing the get and release method of the buffers reader (i.e., the number of bytes encoding payload fragment 1128). As a result, the number of bytes held by the remaining variable of the frames decoder is now equal to the number of bytes encoding payload fragment 1130. The next payload bytes method of the data frame instance returns the list of byte buffers to the read payload bytes method of the frames decoder, and the read payload bytes method of the frames decoder returns the list of byte buffers to the process QUIC data method of the read loop.

In an example embodiment, the system delivers payload fragment 1128 to a stream recipient while the system is executing the process QUIC data method of the read loop (Operation 1210). Outgoing frame 1122 is an HTTP/3 data frame. Accordingly, the appropriate stream recipient is an HTTP subscriber in this example. To deliver payload fragment 1128 to the HTTP subscriber, the system adds payload fragment 1128 to a queue of stream data. The queue of stream data is an instance of a concurrent linked queue class, and the system adds the payload fragment 1128 to the queue of stream data by invoking an add method that is offered by the concurrent linked queue instance. The add method of the concurrent linked queue instance is invoked by the process QUIC data method of the read loop, and the invocation of the add method specifies the list of byte buffers as an input parameter. The system subsequently pushes the payload fragment 1128 to the HTTP subscriber by invoking a push response data method offered by the read loop. The push response data method of the read loop is invoked by the process QUIC data method of the read loop. While executing the push response data method of the read loop, the system transmits the payload fragment 1128 to the HTTP subscriber after verifying that the HTTP subscriber is ready to consume the payload fragment 1128. After delivering payload fragment 1128 to the HTTP subscriber, the byte buffer representing the payload 1120 of incoming frame 1104 may subsequently become less than strongly reachable. Accordingly, the memory space occupied by payload 1120 may become eligible for garbage collection.

### 10. HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

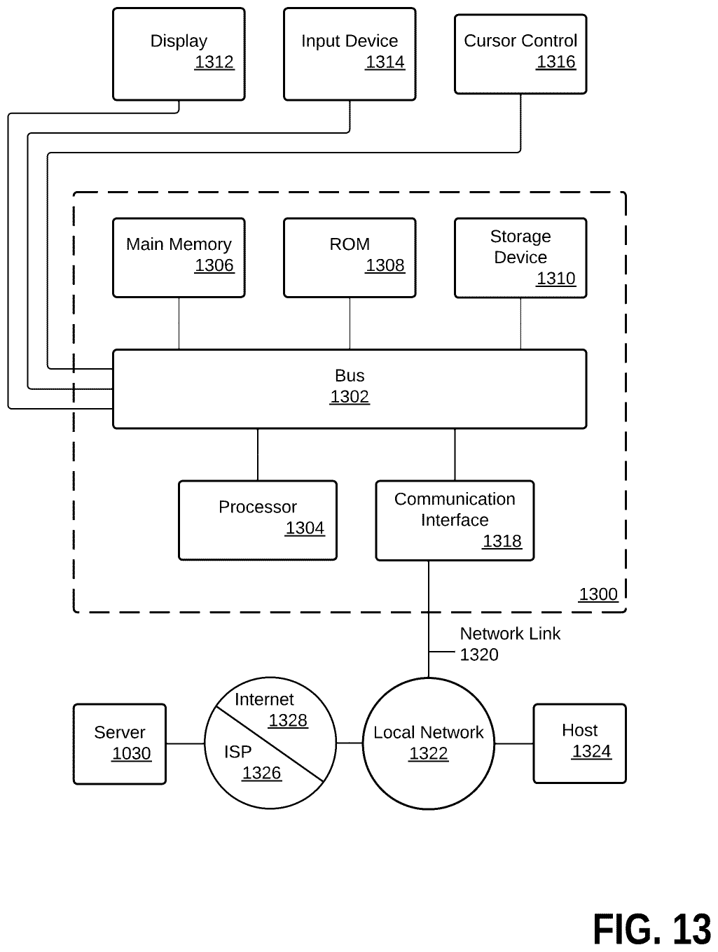

For example, FIG. 13 is a block diagram that illustrates a computer system 1300 upon which an embodiment of the disclosure may be implemented. Computer system 1300 includes a bus 1302 or other communication mechanism for communicating information, and a hardware processor 1304 coupled with bus 1302 for processing information. Hardware processor 1304 may be, for example, a general purpose microprocessor.

Computer system 1300 also includes a main memory 1306, such as a random access memory (RAM) or other dynamic storage device, coupled to bus 1302 for storing information and instructions to be executed by processor 1304. Main memory 1306 also may be used for storing temporary variables or other intermediate information during execution of instructions to be executed by processor 1304. Such instructions, when stored in non-transitory storage media accessible to processor 1304, render computer system 1300 into a special-purpose machine that is customized to perform the operations specified in the instructions.

Computer system 1300 further includes a read only memory (ROM) 1308 or other static storage device coupled to bus 1302 for storing static information and instructions for processor 1304. A storage device 1310, such as a magnetic disk or optical disk, is provided and coupled to bus 1302 for storing information and instructions.

Computer system 1300 may be coupled via bus 1302 to a display 1312, such as a cathode ray tube (CRT), for displaying information to a computer user. An input device 1314, including alphanumeric and other keys, is coupled to bus 1302 for communicating information and command selections to processor 1304. Another type of user input device is cursor control 1316, such as a mouse, a trackball, or cursor direction keys for communicating direction information and command selections to processor 1304 and for controlling cursor movement on display 1312. This input device typically has two degrees of freedom in two axes, a first axis (e.g., x) and a second axis (e.g., y), that allows the device to specify positions in a plane.

Computer system 1300 may implement the techniques described herein using customized hard-wired logic, one or more ASICs or FPGAs, firmware and/or program logic which in combination with the computer system causes or programs computer system 1300 to be a special-purpose machine. According to one embodiment, the techniques herein are performed by computer system 1300 in response to processor 1304 executing one or more sequences of one or more instructions contained in main memory 1306. Such instructions may be read into main memory 1306 from another storage medium, such as storage device 1310. Execution of the sequences of instructions contained in main memory 1306 causes processor 1304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 1310. Volatile media includes dynamic memory, such as main memory 1306. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 1302. Transmission media can also take the form of acoustic or light waves, such as those generated during radio-wave and infra-red data communications.

Various forms of media may be involved in carrying one or more sequences of one or more instructions to processor 1304 for execution. For example, the instructions may initially be carried on a magnetic disk or solid state drive of a remote computer. The remote computer can load the instructions into its dynamic memory and send the instructions over a telephone line using a modem. A modem local to computer system 1300 can receive the data on the telephone line and use an infra-red transmitter to convert the data to an infra-red signal. An infra-red detector can receive the data carried in the infra-red signal and appropriate circuitry can place the data on bus 1302. Bus 1302 carries the data to main memory 1306, from which processor 1304 retrieves and executes the instructions. The instructions received by main memory 1306 may optionally be stored on storage device 1310 either before or after execution by processor 1304.

Computer system 1300 also includes a communication interface 1318 coupled to bus 1302. Communication interface 1318 provides a two-way data communication coupling to a network link 1320 that is connected to a local network 1322. For example, communication interface 1318 may be an integrated services digital network (ISDN) card, cable modem, satellite modem, or a modem to provide a data communication connection to a corresponding type of telephone line. As another example, communication interface 1318 may be a local area network (LAN) card to provide a data communication connection to a compatible LAN. Wireless links may also be implemented. In any such implementation, communication interface 1318 sends and receives electrical, electromagnetic or optical signals that carry digital data streams representing various types of information.

Network link 1320 typically provides data communication through one or more networks to other data devices. For example, network link 1320 may provide a connection through local network 1322 to a host computer 1324 or to data equipment operated by an Internet Service Provider (ISP) 1326. ISP 1326 in turn provides data communication services through the world wide packet data communication network now commonly referred to as the “Internet” 1328. Local network 1322 and Internet 1328 both use electrical, electromagnetic or optical signals that carry digital data streams. The signals through the various networks and the signals on network link 1320 and through communication interface 1318, which carry the digital data to and from computer system 1300, are example forms of transmission media.

Computer system 1300 can send messages and receive data, including program code, through the network(s), network link 1320 and communication interface 1318. In the Internet example, a server 1430 might transmit a requested code for an application program through Internet 1328, ISP 1326, local network 1322 and communication interface 1318.

The received code may be executed by processor 1304 as it is received, and/or stored in storage device 1310, or other non-volatile storage for later execution.

### 11. MISCELLANEOUS; EXTENSIONS

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected, and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A method comprising:
responsive to receiving a first portion of a first frame: buffering the first portion of the first frame, wherein the first frame comprises (a) a first set of frame metadata and (b) a first payload;
decoding at least part of the first set of frame metadata from the first portion of the first frame to determine at least one of: (a) a first frame type of the first frame or (b) a first size of the first payload;
responsive to determining the first frame type of the first frame and/or the first size of the first payload:
generating a first runtime object to represent the first frame, wherein the first runtime object comprises at least one of: (a) a first value indicating the first size of the first payload or (b) a second value indicating an amount of the first payload that that has been delivered to a first recipient;
decoding a first part of the first payload from the first portion of the first frame;
delivering the first part of the first payload to the first recipient; and
updating the second value of the first runtime object to reflect the first part of the first payload being delivered to the first recipient;
responsive to receiving a second portion of the first frame comprising a second part of the first payload:
decoding the second part of the first payload from the second portion of the first frame; and
delivering the second part of the first payload to the first recipient, wherein the second part of the first payload is delivered to the first recipient subsequent to the first part of the first payload being delivered to the first recipient,
wherein the method is performed by at least one device comprising a hardware processor.

2. The method of claim 1, further comprising:
prior to receiving the second portion of the first frame comprising the second part of the first payload:
responsive to delivering the first part of the first payload to the first recipient: reclaiming buffer memory allocated for storing the first portion of the first frame.

3. The method of claim 1, wherein the first runtime object (a) represents the first frame as a partial frame and (b) corresponds to the first frame type of the first frame, and further comprising:
prior to generating the first runtime object:
based, at least in part, on the first frame type of the first frame, determining to deliver the first part of the first payload prior to decoding the second part of the first payload.

4. The method of claim 1, further comprising:
prior to decoding the second part of the first payload:
based, at least in part, on the second value of the first runtime object: determining that at least part of the first payload has not been delivered to the first recipient.

5. The method of claim 1:
wherein the first frame is associated with a higher-layer protocol;
wherein receiving the first portion of the first frame comprises: receiving a second frame associated with a lower-layer protocol, a second payload of the second frame comprising the first portion of the first frame; and
wherein receiving the second portion of the first frame comprises: receiving a third frame associated with the lower-layer protocol, a third payload of the third frame comprising the second portion of the first frame.

6. The method of claim 5:
wherein the higher-layer protocol is a hypertext transfer protocol (HTTP)/3 protocol;
wherein the first frame type is a data frame type of the HTTP/3 protocol;
wherein the lower-layer protocol is a QUIC protocol;
wherein the second frame is a second stream frame of the QUIC protocol; and
wherein the third frame is a third stream frame of the QUIC protocol.

7. The method of claim 5:
wherein storing the first portion of the first frame in memory comprises: (a) generating a second runtime object to represent the second payload of the second frame and (b) adding the second runtime object to a list of runtime objects abstracted by a single runtime object;
wherein data represented by one or more runtime objects comprised within the list of runtime objects abstracted by the single runtime object is presented by the single runtime object as a continuous sequence of elements;
wherein decoding the frame metadata from the first portion of the first frame comprises retrieving the frame metadata from a first set of one or more elements comprised within the continuous sequence of elements;
wherein decoding the first part of the first payload from the first portion of the first frame comprises retrieving the first part of the first payload from a second set of one or more elements comprised within the continuous sequence of elements; and
wherein decoding the second part of the first payload from the second portion of the first frame comprises retrieving the second part of the first payload from a third set of one or more elements comprised within the continuous sequence of elements.

8. The method of claim 7, further comprising:
prior to decoding the second part of the first payload from the second portion of the first frame:
removing the first set of one or more elements from the continuous sequence of elements presented by the single runtime object; and
removing the second set of one or more elements from the continuous sequence of elements presented by the single runtime object.

9. The method of claim 1, further comprising:
responsive to receiving a portion of a second frame: buffering the portion of the second frame, wherein the second frame comprises (a) a second set of frame metadata and (b) a second payload;
decoding at least part of the second set of frame metadata from the portion of the second frame to determine at least one of: (a) a second frame type of the second frame or (b) a second size of the second payload;
responsive to determining the second frame type of the second frame and/or the second size of the second payload:
generating a second runtime object to represent the second frame as a complete frame, wherein a part of the second payload is not delivered to a recipient prior to receiving a remainder of the second frame;
subsequent to receiving the remainder of the second frame:
decoding the second payload from both of (a) the portion of the second frame and (b) the remainder of the second frame; and
delivering the second payload to at least one of: (a) the first recipient or (b) a second recipient.

10. The method of claim 9:
wherein the first frame type is associated with a variable-length payload; and
wherein the second frame type is associated with a fixed-length payload.

11. The method of claim 1, further comprising:
responsive to receiving a dataset comprising at least part of a second frame: buffering the dataset, wherein the second frame comprises (a) a second set of frame metadata and (b) a second payload;
decoding at least part of the second set of frame metadata from the dataset to determine at least one of: (a) a second frame type of the second frame or (b) a second size of the second payload; and
responsive to determining that the second frame type is an unknown frame type: (a) generating a second runtime object to represent the second frame as an unknown frame and (b) discarding the second payload.

12. The method of claim 1, further comprising:
responsive to receiving a dataset comprising at least part of a second frame: buffering the dataset, wherein the second frame comprises (a) a second set of frame metadata and (b) a second payload;
decoding at least part of the second set of frame metadata from the dataset to determine at least one of: (a) a second frame type of the second frame or (b) a second size of the second payload; and
responsive to determining that the second size of the second payload exceeds a maximum size associated with the second frame type: (a) generating a second runtime object to represent the second frame as a malformed frame.

13. One or more non-transitory computer-readable media comprising instructions that, when executed by one or more hardware processors, cause performance of operations comprising:
responsive to receiving a first portion of a first frame: buffering the first portion of the first frame, wherein the first frame comprises (a) a first set of frame metadata and (b) a first payload;
decoding at least part of the first set of frame metadata from the first portion of the first frame to determine at least one of: (a) a first frame type of the first frame or (b) a first size of the first payload;
responsive to determining the first frame type of the first frame and/or the first size of the first payload:
generating a first runtime object to represent the first frame, wherein the first runtime object comprises at least one of: (a) a first value indicating the first size of the first payload or (b) a second value indicating an amount of the first payload that that has been delivered to a first recipient;
decoding a first part of the first payload from the first portion of the first frame;
delivering the first part of the first payload to the first recipient; and
updating the second value of the first runtime object to reflect the first part of the first payload being delivered to the first recipient;
responsive to receiving a second portion of the first frame comprising a second part of the first payload:
decoding the second part of the first payload from the second portion of the first frame; and
delivering the second part of the first payload to the first recipient, wherein the second part of the first payload is delivered to the first recipient subsequent to the first part of the first payload being delivered to the first recipient.

14. The one or more non-transitory computer-readable media of claim 13, wherein the operations further comprise:
prior to receiving the second portion of the first frame comprising the second part of the first payload:
responsive to delivering the first part of the first payload to the first recipient: reclaiming buffer memory allocated for storing the first portion of the first frame.

15. The one or more non-transitory computer-readable media of claim 13, wherein the first runtime object (a) represents the first frame as a partial frame and (b) corresponds to the first frame type of the first frame, and wherein the operations further comprise:
prior to generating the first runtime object:
based, at least in part, on the first frame type of the first frame, determining to deliver the first part of the first payload prior to decoding the second part of the first payload.

16. The one or more non-transitory computer-readable media of claim 13, wherein the operations further comprise:
prior to decoding the second part of the first payload:
based, at least in part, on the second value of the first runtime object: determining that at least part of the first payload has not been delivered to the first recipient.

17. The one or more non-transitory computer-readable media of claim 13, wherein the operations further comprise:
wherein the first frame is associated with a higher-layer protocol;
wherein receiving the first portion of the first frame comprises: receiving a second frame associated with a lower-layer protocol, a second payload of the second frame comprising the first portion of the first frame; and
wherein receiving the second portion of the first frame comprises: receiving a third frame associated with the lower-layer protocol, a third payload of the third frame comprising the second portion of the first frame.

18. The one or more non-transitory computer-readable media of claim 17:
wherein the higher-layer protocol is a hypertext transfer protocol (HTTP)/3 protocol;
wherein the first frame type is a data frame type of the HTTP/3 protocol;
wherein the lower-layer protocol is a QUIC protocol;
wherein the second frame is a second stream frame of the QUIC protocol; and
wherein the third frame is a third stream frame of the QUIC protocol.

19. The one or more non-transitory computer-readable media of claim 17:
wherein storing the first portion of the first frame in memory comprises: (a) generating a second runtime object to represent the second payload of the second frame and (b) adding the second runtime object to a list of runtime objects abstracted by a single runtime object;
wherein data represented by one or more runtime objects comprised within the list of runtime objects abstracted by the single runtime object is presented by the single runtime object as a continuous sequence of elements;
wherein decoding the frame metadata from the first portion of the first frame comprises retrieving the frame metadata from a first set of one or more elements comprised within the continuous sequence of elements;
wherein decoding the first part of the first payload from the first portion of the first frame comprises retrieving the first part of the first payload from a second set of one or more elements comprised within the continuous sequence of elements; and
wherein decoding the second part of the first payload from the second portion of the first frame comprises retrieving the second part of the first payload from a third set of one or more elements comprised within the continuous sequence of elements.

20. A system comprising:
at least one device including a hardware processor;
the system being configured to perform operations comprising:
responsive to receiving a first portion of a first frame: buffering the first portion of the first frame, wherein the first frame comprises (a) a first set of frame metadata and (b) a first payload;
decoding at least part of the first set of frame metadata from the first portion of the first frame to determine at least one of: (a) a first frame type of the first frame or (b) a first size of the first payload;
responsive to determining the first frame type of the first frame and/or the first size of the first payload:
generating a first runtime object to represent the first frame, wherein the first runtime object comprises at least one of: (a) a first value indicating the first size of the first payload or (b) a second value indicating an amount of the first payload that that has been delivered to a first recipient;
decoding a first part of the first payload from the first portion of the first frame;
delivering the first part of the first payload to the first recipient; and
updating the second value of the first runtime object to reflect the first part of the first payload being delivered to the first recipient;
responsive to receiving a second portion of the first frame comprising a second part of the first payload:
decoding the second part of the first payload from the second portion of the first frame; and
delivering the second part of the first payload to the first recipient, wherein the second part of the first payload is delivered to the first recipient subsequent to the first part of the first payload being delivered to the first recipient.
